(19) United States
(12) Patent Application Publication
(10) Pub. No.: US 2023/0368075 A1
(43) Pub. Date: Nov. 16, 2023

(54) INFORMATION PROCESSING METHOD, INFORMATION PROCESSING APPARATUS, AND PROGRAM

(71) Applicant: FUJIFILM Corporation, Tokyo (JP)

(72) Inventors: Masahiro SATO, Tokyo (JP); Tomoki TANIGUCHI, Tokyo (JP); Tomoko OHKUMA, Tokyo (JP)

(73) Assignee: FUJIFILM Corporation, Tokyo (JP)

(21) Appl. No.: 18/311,883

(22) Filed: May 3, 2023

(30) Foreign Application Priority Data
May 16, 2022 (JP) 2022-080147

(51) Int. Cl. G06N 20/00; G06Q 30/0601; G06Q 30/0202

(52) U.S. Cl. CPC G06N 20/00; G06Q 30/0631; G06Q 30/0202

(57) ABSTRACT

There is provided an information processing method, an information processing apparatus, and a program capable of preparing a high performance model for an unknown introduction destination facility even in a case where a domain of the introduction destination facility is unknown at a step of training a model.

An information processing method executed by one or more processors, in which the one or more processors include representing characteristics of a plurality of second facilities different from a first facility where a dataset, which is used for a training of a model that predicts a behavior of a user on an item, is collected, and training a plurality of the models such that prediction performance at each of the second facilities is improved according to the characteristics of each of the second facilities.

### CROSS-REFERENCE TO RELATED APPLICATION

The present application claims priority under 35 U.S.C § 119(a) to Japanese Patent Application No. 2022-080147 filed on May 16, 2022, which is hereby expressly incorporated by reference, in its entirety, into the present application.

### BACKGROUND OF THE INVENTION

### 1. Field of the Invention

The present disclosure relates to an information processing method, an information processing apparatus, and a program, and more particularly to an information suggestion technique for making a robust suggestion for a domain shift.

### 2. Description of the Related Art

In a system that provides various items to a user, such as an electronic commerce (EC) site or a document information management system, it is difficult for the user to select the best item that suits the user from among many items in terms of time and cognitive ability. The item in the EC site is a product handled in the EC site, and the item in the document information management system is document information stored in the system.

In order to assist the user in selecting an item, an information suggestion technique, which is a technique of presenting a selection candidate from a large number of items, has been studied. In general, in a case where a suggestion system is introduced into a certain facility or the like, a model of the suggestion system is trained based on data collected at the introduction destination facility or the like. However, in a case where the same suggestion system is introduced in a facility different from the facility where the data used for the training is collected, there is a problem that the prediction accuracy of the model is decreased. The problem that a machine learning model does not work well at unknown other facilities is called domain shift, and research related to domain generalization, which is research on improving robustness against the domain shift, has been active in recent years, mainly in the field of image recognition. However, there have been few research cases on domain generalization in the information suggestion technique.

A method of selecting a model, which is used for a transition learning, that is, a pre-trained model for a fine-tuning among models trained in several different languages in interlanguage transition learning applied to cross-language translation, is disclosed in Yu-Hsiang Lin, Chian-Yu Chen, Jean Lee, Zirui Li, Yuyan Zhang, Mengzhou Xia, Shruti Rijhwani, Junxian He, Zhisong Zhang, Xuezhe Ma, Antonios Anastasopoulos, Patrick Littell, Graham Neubig “Choosing Transfer Languages for Cross-Lingual Learning” (ACL 2019).

JP2021-197181A discloses a method of classifying users into a plurality of groups and generating a prediction model for providing a service by using an associative learning for each group.

JP2016-062509A discloses a method of classifying users into groups by using user attributes or Dirichlet processes and generating a prediction model for each group, for the purpose of reducing the time required to predict behaviors on the Internet performed by the users operating user terminals.

JP2021-086558A discloses a method of selecting training data, which is used for generating artificial intelligence (AI) for a medical facility such as a hospital, based on attribute information of medical data and the like.

### SUMMARY OF THE INVENTION

It is not considered whether a model as a candidate for the transition learning sufficiently covers a conceivable transition destination language in Yu-Hsiang Lin, Chian-Yu Chen, Jean Lee, Zirui Li, Yuyan Zhang, Mengzhou Xia, Shruti Rijhwani, Junxian He, Zhisong Zhang, Xuezhe Ma, Antonios Anastasopoulos, Patrick Littell, Graham Neubig “Choosing Transfer Languages for Cross-Lingual Learning” (ACL 2019). Therefore, an appropriate model may not be present depending on the transition destination language. In this regard, Yu-Hsiang Lin, Chian-Yu Chen, Jean Lee, Zirui Li, Yuyan Zhang, Mengzhou Xia, Shruti Rijhwani, Junxian He, Zhisong Zhang, Xuezhe Ma, Antonios Anastasopoulos, Patrick Littell, Graham Neubig “Choosing Transfer Languages for Cross-Lingual Learning” (ACL 2019) is a study on transition learning, that is, domain adaptation, not on domain generalization, and since model learning is also performed in the transition destination language, the possibility that a suitable model is not present among a plurality of model candidates is not much of a problem.

In JP2021-197181A, a plurality of prediction models are prepared for the plurality of groups, but since each of the models is a model trained by using a part of user data, it does not necessarily include a model suitable for an unknown group outside the trained group.

In JP2016-062509A, a prediction model suitable for the user is selected from the prediction models generated for each group. In JP2016-062509A, the purpose of dividing users into groups is to reduce explanatory variables required for the prediction model and to shorten calculation time of a prediction value. A plurality of prediction models are also prepared for the plurality of groups in JP2016-062509A as in JP2021-197181A, but since each of the models is a model trained by using a part of user data, it does not necessarily include a model suitable for an unknown group outside the trained group.

In JP2021-086558A, training data is selected such that bias of attributes of medical data is small, and training data is selected such that test data of a medical facility using a trained AI and attribute distribution are close to each other. Although the technology described in JP2021-086558A builds a model assuming a facility different from the facility where training data is obtained, it prepares only a single model, and its effectiveness is limited only in a case where the introduction destination facility is known. That is, the technology described in JP2021-086558A cannot be applied unless the data of the introduction destination facility is known at the time of a training.

At the development step of the model, data for training about the facility may not be available, in a case where the introduction destination facility is undecided, or even in a case where the introduction destination is specified. Therefore, even in these cases, it is desired to realize effective information suggestion in the introduction destination facility which can be assumed.

As one of methods for realizing such information suggestion, for example, even in a case where the data of the introduction destination facility in the case of model learning is not obtained, in a case where there is data collected at the introduction destination facility in the case of introduction, the optimal model can be selected from among a plurality of candidates by evaluating the candidate models by using that data.

However, in a case where the performance, which is obtained by evaluating the data of the introduction destination facility, is low in any of the plurality of candidate models prepared in advance, it is difficult to perform high performance information suggestion at the introduction destination facility. In order to avoid such a situation, there is a need for technology that builds a plurality of models that can deal with various unknown domains to ensure that at least one or more suitable models are included in a candidate model set including a plurality of candidate models in the case of any introduction destination facility.

The present disclosure has been made in view of such circumstances, and it is an object of the present disclosure to provide an information processing method, an information processing apparatus, and a program capable of preparing a high performance model for an unknown introduction destination facility even in a case where a domain of the introduction destination facility is unknown at a step of training a model.

An information processing method according to a first aspect of the present disclosure is an information processing method executed by one or more processors, in which the one or more processors comprise: representing characteristics of a plurality of second facilities different from a first facility where a dataset, which is used for a training of a model that predicts a behavior of a user on an item, is collected; and training a plurality of the models such that prediction performance at each of the second facilities is improved according to the characteristics of each of the second facilities.

According to the present aspect, a plurality of models with improved prediction performance are generated in each of the plurality of second facilities having characteristics different from those of the first facility where the dataset is collected. It is possible to ensure the diversity of the plurality of models by representing various characteristics as the characteristics of the second facility. It is possible to build a diverse group of models (a set of a plurality of models) including high performance models in an unknown introduction destination facility by representing the characteristics of each of the plurality of second facilities so as to cover a range of possible characteristics of the unknown facility that is assumed to be the introduction destination of the model and by training the model such that the prediction performance improves at each of the second facilities.

The second facility may be a hypothetical facility that can be assumed as an unknown introduction destination facility. The second facility may be an existing facility or a non-existing facility. The facility includes the concept of a group including a plurality of users, for example, a company, a hospital, a store, a government agency, or an EC site. Each of the facilities can be in a different domain from each other.

The information processing method of the present disclosure can be understood as a machine learning method for generating a model applied to a system that performs an information suggestion. Further, the information processing method of the present disclosure can be understood as a method (manufacturing method) for producing a model.

In the information processing method of a second aspect of the present disclosure according to the information processing method of the first aspect, the one or more processors may be configured to train the plurality of models corresponding to each of the plurality of second facilities by using data included in the dataset based on the characteristics of each of the second facilities. It is possible to train a plurality of models corresponding to each of the plurality of second facilities from one dataset.

In the information processing method of a third aspect of the present disclosure according to the information processing method of the first or second aspect, a plurality of the datasets, which are collected from each of a plurality of the first facilities, may be prepared, and the one or more processors may be configured to: represent the characteristics of each of the second facilities different from each of the first facilities; and train the plurality of models by using data included in each of the datasets based on the characteristics of each of the second facilities. By training the models corresponding to each of the second facilities different from each of the plurality of datasets of the domains different from each other, it is possible to generate the plurality of models corresponding to each of the plurality of second facilities as a whole.

In the information processing method of a fourth aspect of the present disclosure according to the information processing method of any one of the first to third aspects, the one or more processors may be configured to represent a difference in a probability distribution of explanatory variables in the first facility and the second facility, as a representation of the characteristic of the second facility.

In the information processing method of a fifth aspect of the present disclosure according to the information processing method of any one of the first to fourth aspects, the one or more processors may be configured to represent a difference in a conditional probability between explanatory variables and response variables in the first facility and the second facility, as a representation of the characteristic of the second facility.

In the information processing method of a sixth aspect of the present disclosure according to the information processing method of any one of the first to fifth aspects, the one or more processors may be configured to perform the training by sampling data, which is used for the training, from the dataset, according to the characteristic of the second facility. The one or more processors may simulate the data of the second facility from existing datasets by performing the up-sampling and/or down-sampling of the data by reflecting differences in the characteristic of the second facility with respect to the characteristic of the first facility.

In the information processing method of a seventh aspect of the present disclosure according to the information processing method of any one of the first to sixth aspects, the one or more processors may be configured to perform the training by weighting data included in the dataset, according to the characteristic of the second facility. The one or more processors may simulate the effect of a training in a case where unknown data of the second facility is used by performing weighting of the data used for training by reflecting the difference in the characteristic of the second facility with respect to the characteristic of the first facility.

In the information processing method of an eighth aspect of the present disclosure according to the information processing method of any one of the first to seventh aspects, the one or more processors may include selecting a feature amount used in the model, according to the characteristic of the second facility. The difference in the characteristics between the first facility and the second facility may be represented as a difference in the feature amounts used in the model.

In the information processing method of a ninth aspect of the present disclosure according to the information processing method of the eighth aspect, the one or more processors may include performing the training by deleting a part of a cross feature amount, which is represented by a combination of explanatory variables, from the feature amount of the model. It is preferable to train by excluding the cross feature amount that is significantly different between different facilities from the feature amount of the model.

In the information processing method of a tenth aspect of the present disclosure according to the information processing method of any one of the first to ninth aspects, the model may be a prediction model used in a suggestion system that suggests an item to a user, and the characteristic of the second facility, which is represented by the one or more processors, may be a characteristic of a hypothetical facility assumed within a range of a characteristic of a facility capable of being an introduction destination facility of the suggestion system.

In the information processing method of an eleventh aspect of the present disclosure according to the information processing method of any one of the first to tenth aspects, the dataset may include a behavior history of a plurality of users on a plurality of items in the first facility.

In the information processing method of a twelfth aspect of the present disclosure according to the information processing method of any one of the first to eleventh aspects, the one or more processors may include storing a set of a plurality of candidate models, which include the plurality of models generated by performing the training, in a storage device.

In the information processing method of a thirteenth aspect of the present disclosure according to the information processing method of any one of the first to twelfth aspects, the one or more processors may include storing a set of a plurality of candidate models, which include a first model that is trained to improve prediction performance at the first facility by using data included in the dataset and a plurality of second models that are the plurality of models trained based on the characteristics of each of the plurality of second facilities, in a storage device.

The processor that executes the training of the first model may be a processor different from the one or more processors that execute the training of the second model. The first model may be prepared as an existing model.

In the information processing method of a fourteenth aspect of the present disclosure according to the information processing method of the thirteenth aspect, the one or more processors may include training the first model by using the data included in the dataset.

In the information processing method of a fifteenth aspect of the present disclosure according to the information processing method of any one of the first to fourteenth aspects the one or more processors may include evaluating performance of each of a plurality of candidate models including the plurality of models by using data collected at a third facility that is different from the first facility and extracting a model suitable for the third facility from among the plurality of candidate models based on an evaluation result.

An information processing apparatus according to a sixteenth aspect of the present disclosure comprises: one or more processors; and one or more memories, in which an instruction executed by the one or more processors is stored, in which the one or more processors are configured to: represent characteristics of a plurality of second facilities different from a first facility where a dataset, which is used for a training of a model that predicts a behavior of a user on an item, is collected; and train a plurality of the models such that prediction performance at each of the second facilities is improved according to the characteristics of each of the second facilities.

The information processing apparatus according to the sixteenth aspect can include the same specific aspect as the information processing method according to any one of the second to fifteenth aspects described above.

A program according to a seventeenth aspect of the present disclosure causes a computer to realize: a function of representing characteristics of a plurality of second assumed facilities different from a first facility where a dataset, which is used for a training of a model that predicts a behavior of a user on an item, is collected; and a function of training a plurality of the models such that prediction performance at each of the second facilities is improved according to the characteristics of each of the second facilities.

The program according to the seventeenth aspect can include the same specific aspect as the information processing method according to any one of the second to fifteenth aspects described above.

According to the present disclosure, even in a case where the domain of the introduction destination facility is unknown at the step of training the model, it is possible to generate a plurality of models corresponding to various facilities, and a high performance model can be prepared for the unknown introduction destination facility.

### BRIEF DESCRIPTION OF THE DRAWINGS

FIG. 1 is a conceptual diagram of a typical suggestion system.

FIG. 2 is a conceptual diagram showing an example of machine learning with a teacher that is widely used in building a suggestion system.

FIG. 3 is an explanatory diagram showing a typical introduction flow of the suggestion system.

FIG. 4 is an explanatory diagram of an introduction flow of the suggestion system in a case where data of an introduction destination facility cannot be obtained.

FIG. 5 is an explanatory diagram in a case where a model is trained by domain adaptation.

FIG. 6 is an explanatory diagram of an introduction flow of the suggestion system including a step of evaluating the performance of the trained model.

FIG. 7 is an explanatory diagram showing an example of training data and evaluation data used for the machine learning.

FIG. 8 is a graph schematically showing a difference in performance of a model due to a difference in a dataset.

FIG. 9 is an explanatory diagram showing an example of an introduction flow of the suggestion system in a case where a learning domain and an introduction destination domain are different from each other.

FIG. 10 is an explanatory diagram showing a problem in a case where the learning domain and the introduction destination domain are different from each other.

FIG. 11 is an explanatory diagram showing an example of a diversity of candidate models.

FIG. 12 is an explanatory diagram showing a diversity of facilities assumed as an introduction destination of the suggestion system.

FIG. 13 is a conceptual diagram in a case where a model suitable for prediction in each facility shown in FIG. 12 is prepared.

FIG. 14 is an explanatory diagram showing an example of a learning facility where a dataset used for a training is collected.

FIG. 15 is an explanatory diagram showing a relationship between a model, which is generated by performing training using data that is collected from the learning facility shown in FIG. 14, and facility characteristics.

FIG. 16 is an explanatory diagram showing that a model, which is suitable for a facility having characteristics different from the learning facility, is trained by using the data collected from the learning facility.

FIG. 17 is a block diagram schematically showing an example of a hardware configuration of an information processing apparatus according to an embodiment.

FIG. 18 is a functional block diagram showing a functional configuration of an information processing apparatus.

FIG. 19 is a chart showing an example of behavior history data.

FIG. 20 is a graph showing an example of an age distribution of users in the learning facility.

FIG. 21 is an example of a directed acyclic graph (DAG) representing a dependency relationship between variables of a simultaneous probability distribution P(X, Y).

FIG. 22 is a diagram showing a specific example of a probability representation of a conditional probability distribution P(Y|X).

FIG. 23 is an explanatory diagram showing a relationship between an expression, which represents a conditional probability of behaviors of a user on an item (Y=1) for a combination of a user behavior characteristic and an item characteristic, and a DAG representing a dependency relationship between variables of the simultaneous probability distribution P(X, Y).

FIG. 24 is an explanatory diagram showing a relationship among a user behavior characteristic defined by a combination of user attribute 1 and user attribute 2, an item behavior characteristic defined by a combination of item attribute 1 and item attribute 2, and a DAG that represents a dependency relationship between variables.

FIG. 25 is an explanatory diagram showing an example in a case where learning data is sampled according to the characteristics of a hypothetical facility from a dataset of the learning facility.

FIG. 26 is an explanatory diagram in a case where the weighting of the learning data is changed according to the characteristics of the hypothetical facility.

FIG. 27 is a graph schematically showing an example of what kind of document is being browsed by a user in what department in a certain company.

FIG. 28 is an explanatory diagram showing an example in which an inner product between a user characteristic vector and an item characteristic vector is represented as the sum of inner products of attribute vectors.

FIG. 29 is an explanatory diagram in a case where vector representations, which become different depending on cross targets, are used.

### DESCRIPTION OF THE PREFERRED EMBODIMENTS

Hereinafter, preferred embodiments of the present invention will be described with reference to the accompanying drawings.

Overview of Information Suggestion Technique

First, the outline and problems of an information suggestion technique will be outlined by showing specific examples. The information suggestion technique is a technique for suggesting an item to a user.

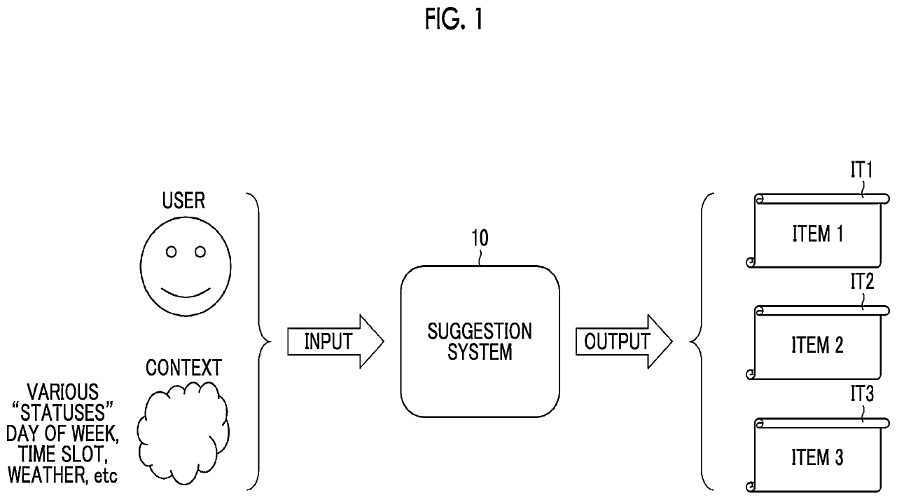

FIG. 1 is a conceptual diagram of a typical suggestion system 10. The suggestion system 10 receives user information and context information as inputs and outputs information of the item that is suggested to the user according to a context. The context means various “statuses” and may be, for example, a day of the week, a time slot, or the weather. The items may be various objects such as a book, a video, a restaurant, and the like.

The suggestion system 10 generally suggests a plurality of items at the same time. FIG. 1 shows an example in which the suggestion system 10 suggests three items of IT1, IT2, and IT3. In a case where the user responds positively to the suggested items IT1, IT2, and IT3, the suggestion is generally considered to be successful. A positive response is, for example, a purchase, browsing, or visit. Such a suggestion technique is widely used, for example, in an EC site, a gourmet site that introduces a restaurant, or the like.

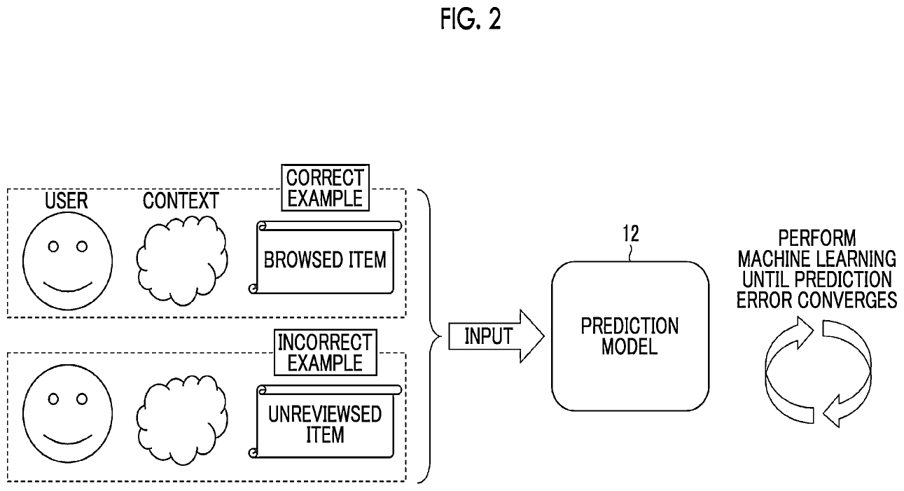

The suggestion system 10 is built by using a machine learning technique. FIG. 2 is a conceptual diagram showing an example of machine learning with a teacher that is widely used in building the suggestion system 10. Generally, a positive example and a negative example are prepared based on a behavior history of the user in the past, a combination of the user and the context is input to a prediction model 12, and the prediction model 12 is trained such that a prediction error becomes small. For example, a browsed item that is browsed by the user is defined as a positive example, and a non-browsed item that is not browsed by the user is defined as a negative example. The machine learning is performed until the prediction error converges, and the target prediction performance is acquired.

By using the trained prediction model 12, which is trained in this way, items with a high browsing probability, which is predicted with respect to the combination of the user and the context, are suggested. For example, in a case where a combination of a certain user A and a context β is input to the trained prediction model 12, the prediction model 12 infers that the user A has a high probability of browsing a document such as the item IT3 under a condition of the context β and suggests an item similar to the item IT3 to the user A. Depending on the configuration of the suggestion system 10, items are often suggested to the user without considering the context.

Example of Data Used for Developing Suggestion System

The user behavior history is substantially equivalent to “correct answer data” in machine learning. Strictly speaking, it is understood as a task setting of inferring the next (unknown) behavior from the past behavior history, but it is general to train the potential feature amount based on the past behavior history.

The user behavior history may include, for example, a book purchase history, a video browsing history, or a restaurant visit history.

Further, main feature amounts include a user attribute and an item attribute. The user attribute may have various elements such as, for example, gender, age group, occupation, family members, and residential area. The item attribute may have various elements such as a book genre, a price, a video genre, a length, a restaurant genre, and a place.

Model Building and Operation

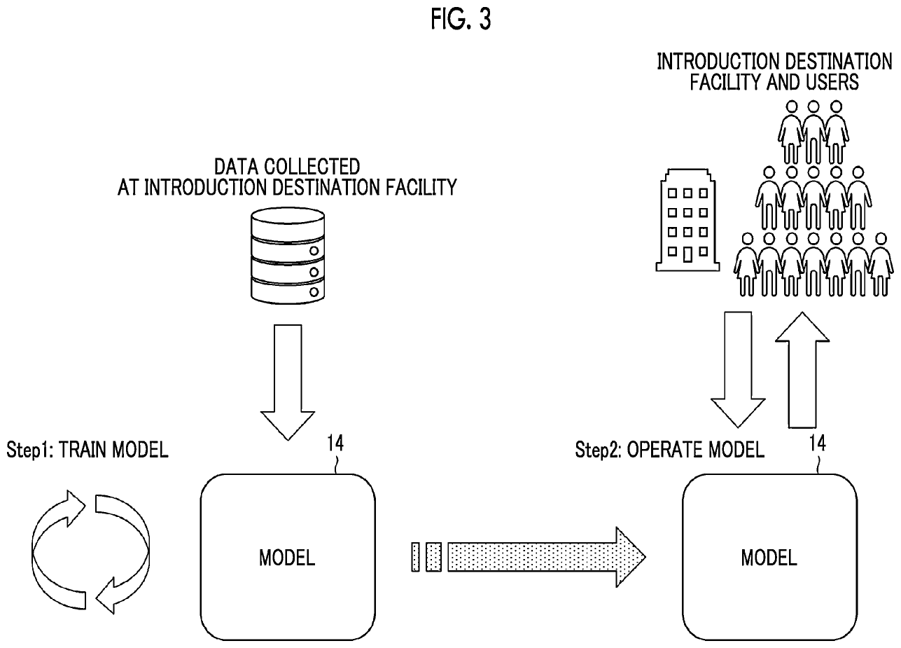

FIG. 3 is an explanatory diagram showing a typical introduction flow of the suggestion system. Here, a typical flow in a case where the suggestion system is introduced to a certain facility, is shown. To introduce the suggestion system, first, a model 14 for performing a target suggestion task is built (step 1), and then the built model 14 is introduced and operated (step 2). In the case of a machine learning model, “Building” the model 14 includes training the model 14 by using training data to create a prediction model (suggestion model) that satisfies a practical level of suggestion performance. “Operating” the model 14 is, for example, obtaining an output of a suggested item list from the trained model 14 with respect to the input of the combination of the user and the context.

Data for a training is required for building the model 14. As shown in FIG. 3, in general, the model 14 of the suggestion system is trained based on the data collected at an introduction destination facility. By performing training by using the data collected from the introduction destination facility, the model 14 learns the behavior of the user in the introduction destination facility and can accurately predict suggestion items for the user in the introduction destination facility.

However, due to various circumstances, it may not be possible to obtain data on the introduction destination facility. For example, in the case of a document information suggestion system in an in-house system of a company or an in-hospital system of a hospital, a company that develops a suggestion model often cannot access the data of the introduction destination facility. In a case where the data of the introduction destination facility cannot be obtained, instead, it is necessary to perform training based on data collected at different facilities.

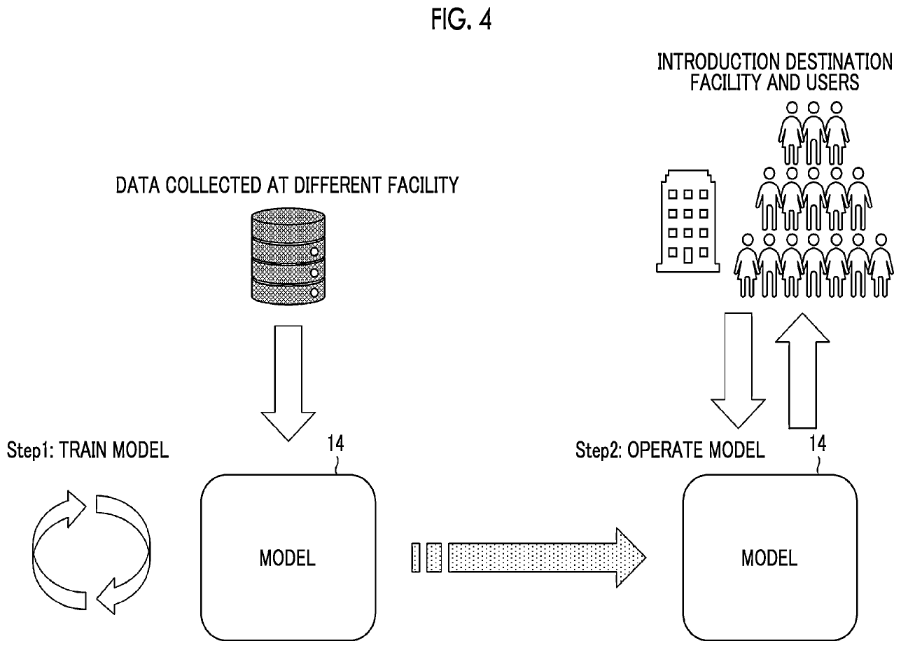

FIG. 4 is an explanatory diagram of an introduction flow of the suggestion system in a case where data of an introduction destination facility cannot be obtained. In a case where the model 14, which is trained by using the data collected in a facility different from the introduction destination facility, is operated in the introduction destination facility, there is a problem that the prediction accuracy of the model 14 decreases due to differences in user behavior between facilities.

The problem that the machine learning model does not work well in unknown facilities different from the trained facility is understood as a technical problem, in a broad sense, to improve robustness against a problem of domain shift in which a source domain where the model 14 is trained differs from a target domain where the model 14 is applied. As a problem setting related to domain generalization includes domain adaptation. This is a method of training by using data from both the source domain and the target domain. The purpose of using the data of different domains in spite of the presence of the data of the target domain is to make up for the fact that the amount of data of the target domain is small and insufficient for a training.

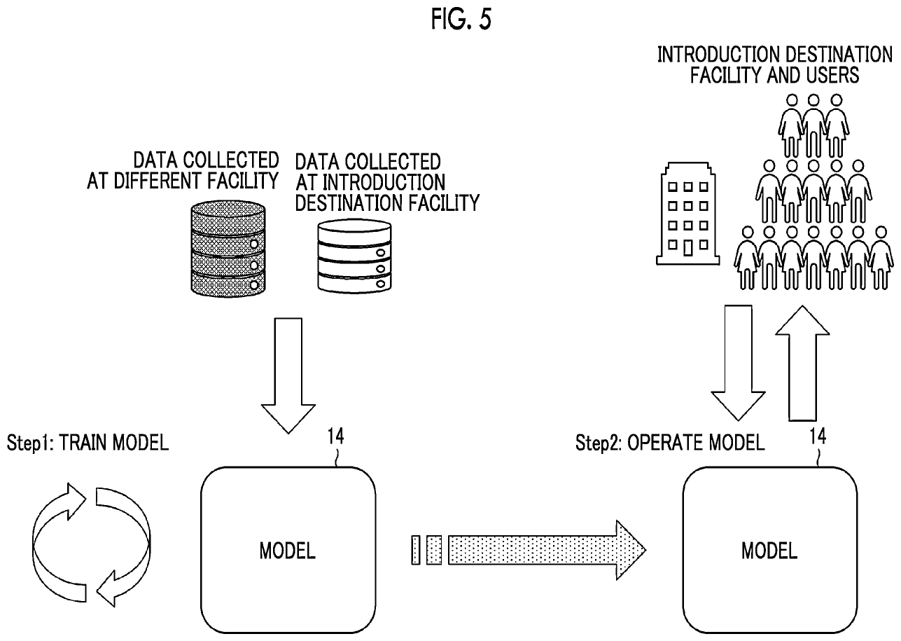

FIG. 5 is an explanatory diagram in a case where the model 14 is trained by domain adaptation. Although the amount of data collected at the introduction destination facility that is the target domain is relatively smaller than the data collected at a different facility, the model 14 can also predict with a certain degree of accuracy the behavior of the users in the introduction destination facility by performing a training by using both data.

Description of Domain

The above-mentioned difference in a “facility” is a kind of difference in a domain. In Ivan Cantador et al, Chapter 27:“Cross-domain Recommender System”, which is a document related to research on domain adaptation in information suggestion, differences in domains are classified into the following four categories.
[1] Item attribute level: For example, a comedy movie and a horror movie are in different domains.
[2] Item type level: For example, a movie and a TV drama series are in different domains.
[3] Item level: For example, a movie and a book are in different domains.
[4] System level: For example, a movie in a movie theater and a movie broadcast on television are in different domains.

The difference in “facility” shown in FIG. 5 or the like corresponds to [4] system-level domain in the above four categories.

In a case where a domain is formally defined, the domain is defined by a simultaneous probability distribution P(X, Y) of a response variable Y and an explanatory variable X, and in a case where Pd1 (X, Y)≠Pd2(X, Y), d1 and d2 are different domains.

The simultaneous probability distribution P(X, Y) can be represented by a product of an explanatory variable distribution P(X) and a conditional probability distribution P(Y|X) or a product of a response variable distribution P(Y) and a conditional probability distribution P(Y|X).

P(X,Y)=P(Y|X)P(X)=P(X|Y)P(Y)

Therefore, in a case where one or more of P(X), P(Y), P(Y|X), and P(X|Y) is changed, the domains become different from each other.

Typical Pattern of Domain Shift

Covariate Shift

A case where distributions P(X) of explanatory variables are different is called a covariate shift. For example, a case where distributions of user attributes are different between datasets, more specifically, a case where a gender ratio is different, and the like correspond to the covariate shift.

Prior Probability Shift

A case where distributions P(Y) of the response variables are different is called a prior probability shift. For example, a case where an average browsing ratio or an average purchase ratio differs between datasets corresponds to the prior probability shift.

Concept Shift

A case where conditional probability distributions P(Y|X) and P(X|Y) are different is called a concept shift. For example, a probability that a research and development department of a certain company reads data analysis materials is assumed as P(Y|X), and in a case where the probability differs between datasets, this case corresponds to the concept shift.

Research on domain adaptation or domain generalization includes assuming one of the above-mentioned patterns as a main factor and looking at dealing with P(X, Y) changing without specifically considering which pattern is a main factor. In the former case, there are many cases in which a covariate shift is assumed.

Reason for Influence of Domain Shift A prediction/classification model that performs a prediction or classification task makes inferences based on a relationship between the explanatory variable X and the response variable, thereby in a case where P(Y|X) is changed, naturally the prediction/classification performance is decreased. Further, although minimization of a prediction/classification error is performed within learning data in a case where machine learning is performed on the prediction/classification model, for example, in a case where the frequency in which the explanatory variable becomes X=X_1 is greater than the frequency in which the explanatory variable becomes X=X_2, that is, in a case where P(X=X_1)>P(X=X_2), the data of X=X_1 is more than the data of X=X_2, thereby error decrease for X=X_1 is trained in preference to error decrease for X=X_2. Therefore, even in a case where P(X) is changed between the facilities, the prediction/classification performance is decreased.

The domain shift can be a problem not only for information suggestion but also for various task models. For example, regarding a model that predicts the retirement risk of an employee, a domain shift may become a problem in a case where a prediction model, which is trained by using data of a certain company, is operated by another company.

Further, in a model that predicts an antibody production amount of a cell, a domain shift may become a problem in a case where a model, which is trained by using data of a certain antibody, is used for another antibody. Further, for a model that classifies the voice of customer (VOC), for example, a model that classifies VOC into “product function”, “support handling”, and “other”, a domain shift may be a problem in a case where a classification model, which is trained by using data related to a certain product, is used for another product.

Regarding Evaluation before Introduction of Model

In many cases, a performance evaluation is performed on the model 14 before the trained model 14 is introduced into an actual facility or the like. The performance evaluation is necessary for determining whether or not to introduce the model and for research and development of models or learning methods.

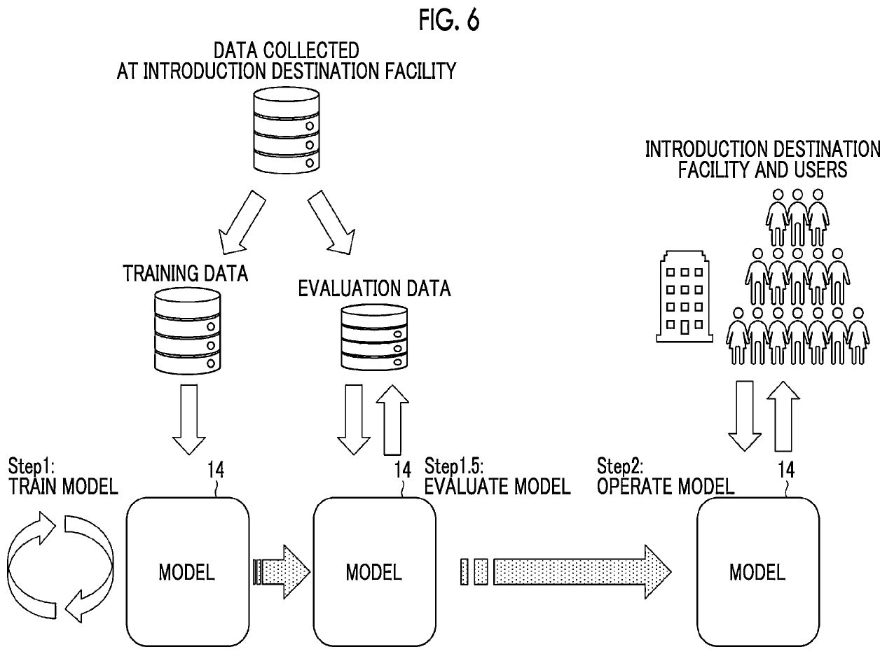

FIG. 6 is an explanatory diagram of an introduction flow of the suggestion system including a step of evaluating the performance of the trained model 14. In FIG. 6, a step of evaluating the performance of the model 14 is added as “step 1.5” between step 1 (the step of training the model 14) and step 2 (the step of operating the model 14) described in FIG. 5. Other configurations are the same as in FIG. 5. As shown in FIG. 6, in a general introduction flow of the suggestion system, the data, which is collected at the introduction destination facility, is often divided into training data and evaluation data. The prediction performance of the model 14 is checked by using the evaluation data, and then the operation of the model 14 is started.

However, in a case of building the model 14 of domain generalization, the training data and the evaluation data need to be different domains. Further, in the domain generalization, it is preferable to use the data of a plurality of domains as the training data, and it is more preferable that there are many domains that can be used for a training.

Regarding Generalization

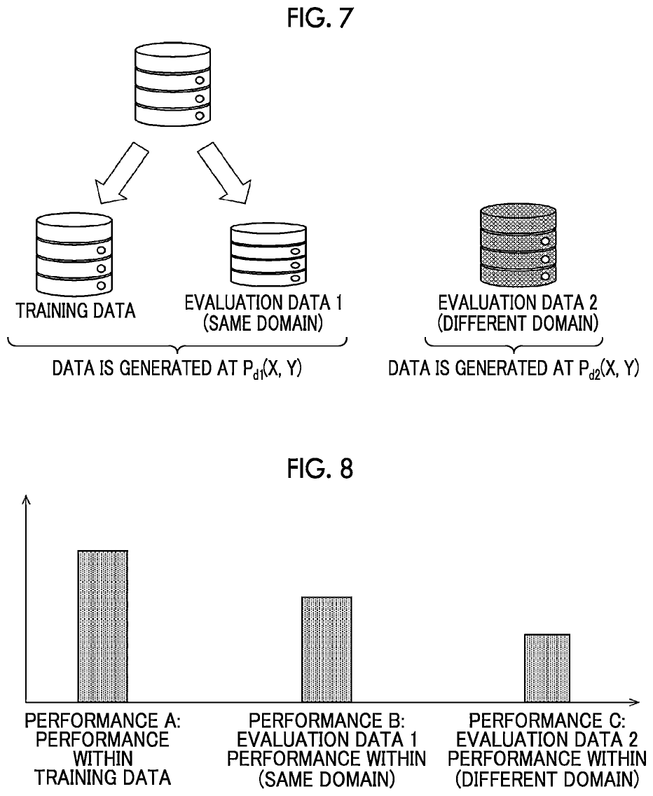

FIG. 7 is an explanatory diagram showing an example of the training data and the evaluation data used for the machine learning. The dataset obtained from the simultaneous probability distribution Pd1(X, Y) of a certain domain d1 is divided into training data and evaluation data. The evaluation data of the same domain as the training data is referred to as “first evaluation data” and is referred to as “evaluation data 1” in FIG. 7. Further, a dataset, which is obtained from a simultaneous probability distribution Pd2(X, Y) of a domain d2 different from the domain d1, is prepared and is used as the evaluation data. The evaluation data of the domain different from the training data is referred to as “second evaluation data” and is referred to as “evaluation data 2” in FIG. 7.

The model 14 is trained by using the training data of the domain d1, and the performance of the model 14, which is trained by using each of the first evaluation data of the domain d1 and the second evaluation data of the domain d2, is evaluated.

FIG. 8 is a graph schematically showing a difference in performance of the model due to a difference in the dataset. Assuming that the performance of the model 14 in the training data is defined as performance A, the performance of the model 14 in the first evaluation data is defined as performance B, and the performance of the model 14 in the second evaluation data is defined as performance C, normally, a relationship is represented such that performance A>performance B>performance C, as shown in FIG. 8.

High generalization performance of the model 14 generally indicates that the performance B is high, or indicates that a difference between the performances A and B is small. That is, the aim is to achieve high prediction performance even for untrained data without over-fitting to the training data.

In the context of domain generalization in the present specification, it means that the performance C is high or a difference between the performance B and the performance C is small. In other words, the aim is to achieve high performance consistently even in a domain different from the domain used for the training.

In the present embodiment, although the data of the introduction destination facility cannot be used in a case where the model 14 is trained, it is assumed that a status where data (correct answer data) including the behavior history collected at the introduction destination facility can be prepared in a case where the model is evaluated before introduction (evaluation before introduction).

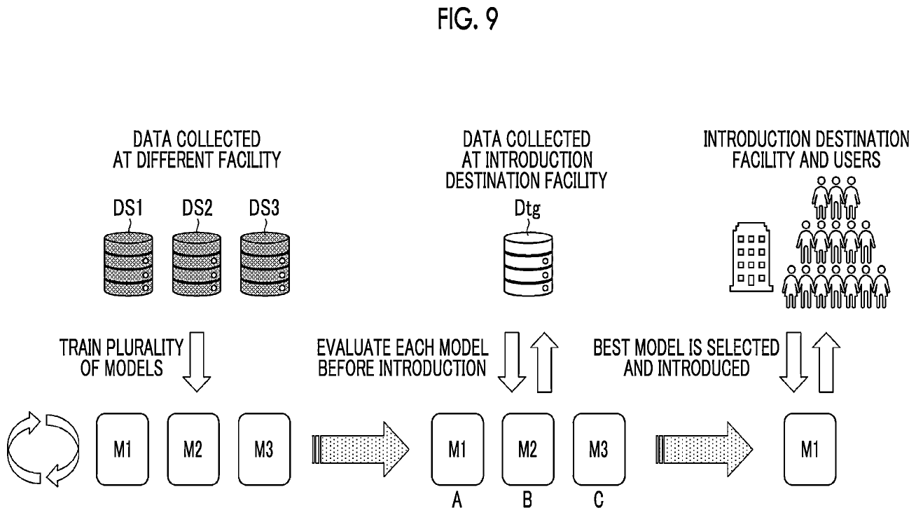

In such cases, by generating a plurality of candidate models by training the model by using the data collected at a facility different from the introduction destination facility and by evaluating the performance of each candidate model by using the data collected at the introduction destination facility, it is conceivable to select the optimal model from among the plurality of candidate models and apply the optimal model to the introduction destination facility based on the results of the evaluation. An example thereof is shown in FIG. 9.

FIG. 9 is an explanatory diagram showing an example of an introduction flow of the suggestion system in a case where a learning domain and an introduction destination domain are different from each other. As shown in FIG. 9, a plurality of models can be trained by using the data collected at a facility different from the introduction destination facility. Here, an example is shown in which training of models M1, M2, and M3 is performed by using datasets DS1, DS2, and DS3 collected at different facilities. For example, the model M1 is trained by using the dataset DS1, the model M2 is trained by using the dataset DS2, and the model M3 is trained by using the dataset DS3. The dataset used for training each of the models M1, M2, and M3 may be a combination of a plurality of datasets collected at different facilities. For example, the model M1 may be trained by using a dataset in which the dataset DS1 and the dataset DS2 are mixed.

In this way, after the plurality of models M1, M2, and M3 are trained, the performance of each of the models M1, M2, and M3 is evaluated by using data Dtg collected at the introduction destination facility. In FIG. 9, the symbols “A”, “B”, and “C” shown below the respective models M1, M2, and M3 represent the evaluation results of the respective models. The evaluation A indicates that the prediction performance satisfies an introduction standard. The evaluation B indicates that the performance is inferior to the evaluation A. The evaluation C is a performance inferior to the evaluation B and indicates that the performance is not suitable for introduction.

For example, as shown in FIG. 9, assuming that the evaluation result of the model M1 is defined as “A”, the evaluation result of the model M2 is defined as “B”, and the evaluation result of model M3 is defined as “C”, the model M1 is selected as the most optimal model at the introduction destination facility, and the suggestion system 10 to which the model M1 is applied is introduced.

Problems

As described in FIG. 9, in a case where any one of the plurality of models M1 to M3 that is trained and prepared in advance has good performance, it is possible to provide a good information suggestion at the introduction destination facility.

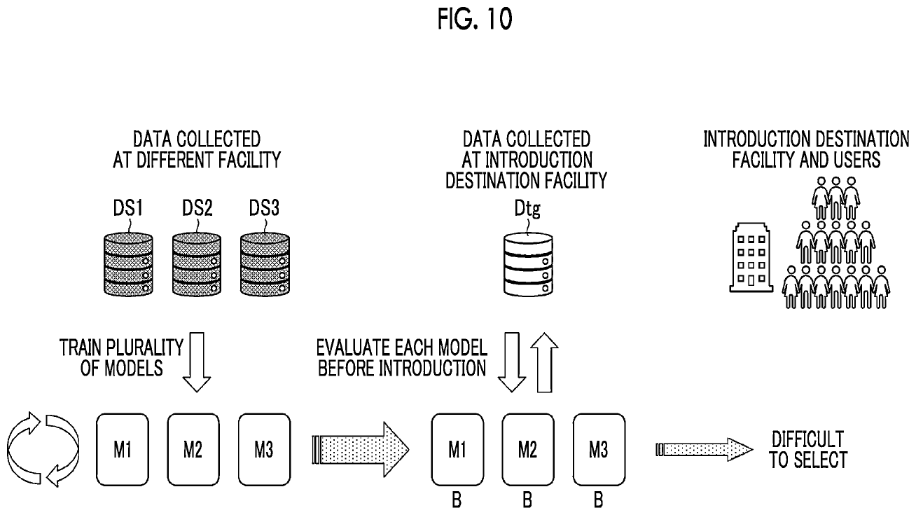

However, in any of the models M1, M2, and M3 trained in advance, it is assumed that the evaluation result of the evaluation before introduction may not be the evaluation A. An example thereof is shown in FIG. 10.

As shown in FIG. 10, in a case where the evaluation results of the models M1, M2, and M3 are all evaluation B, or in a case where the evaluation result is only evaluation B or evaluation C, no matter which model is selected, it is difficult to perform high performance information suggestion at the introduction destination facility.

In order to avoid such a situation, it is important that a plurality of candidate models prepared in advance have sufficient diversity. For example, in a case where the performances of the models M1, M2, and M3 are significantly different from each other, it increases the possibility that either model can be applied in response to differences in the characteristics of facilities that are possible (assumed) as the introduction destination.

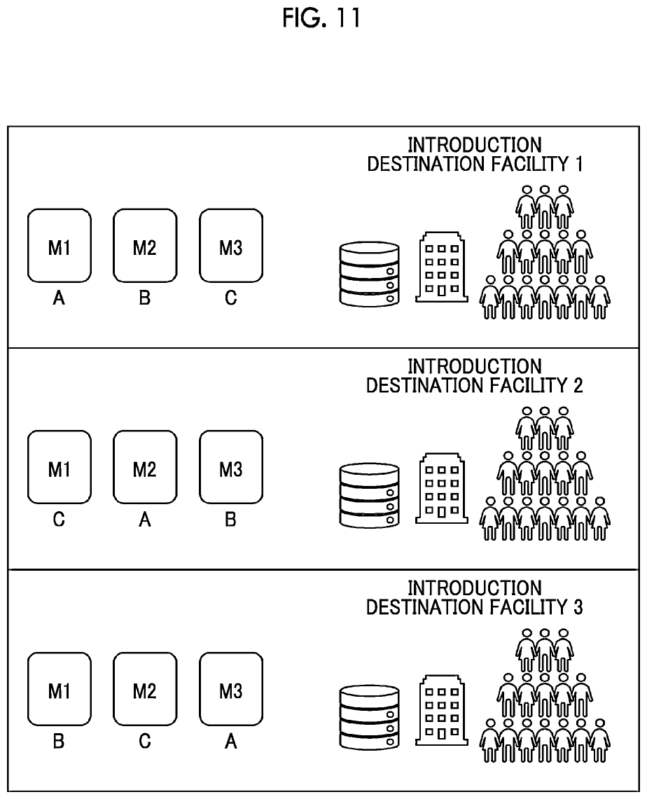

FIG. 11 is an explanatory diagram showing a diversity of candidate models. For example, as shown in FIG. 11, it is assumed that there are three patterns of characteristics of the facility that can be the introduction destination. In the figure, the notations with the number of “introduction destination facility 1”, “introduction destination facility 2”, and “introduction destination facility 3” represent that the facilities have different patterns of facility characteristics from each other.

FIG. 11 shows an example of evaluation results in a case where the performances of three models M1, M2, and M3, which are a plurality of candidate models prepared in advance, are evaluated by using the data of each facility of these three patterns.

Regarding the evaluation results, which are obtained in a case where the performances of the candidate models M1, M2, and M3 are evaluated by using the data collected at the introduction destination facility 1 shown in the upper part of FIG. 11, the model M1 is evaluation A, the model M2 is evaluation B, and the model M3 is evaluation C. Regarding the evaluation results, which are obtained in a case where the performances of the candidate models M1, M2, and M3 are evaluated by using the data collected at the introduction destination facility 2 shown in the middle part in FIG. 11, the model M1 is evaluation C, the model M2 is evaluation A, and the model M3 is evaluation B. Regarding the evaluation results, which are obtained in a case where the performances of the candidate models M1, M2, and M3 are evaluated by using the data of the introduction destination facility 3 shown in the lower part in FIG. 11, the model M1 is evaluation B, the model M2 is evaluation C, and the model M3 is evaluation A.

In this case, the model M1 can be applied to the facility of a first pattern (introduction destination facility 1), the model M2 can be applied to the facility of a second pattern (introduction destination facility 2), and the model M3 can be applied to the facility of a third pattern (introduction destination facility 3).

As described above, it is desired to prepare a plurality of candidate models having a diversity such that one or more good models are included regardless of the introduction destination. A set of a plurality of candidate models is called a candidate model set.

In the present embodiment, as shown in FIG. 11, the aim is to achieve building a plurality of candidate models such that at least one or more good models (a model with evaluation A) is included in the candidate model set even for any unknown introduction destination facility.

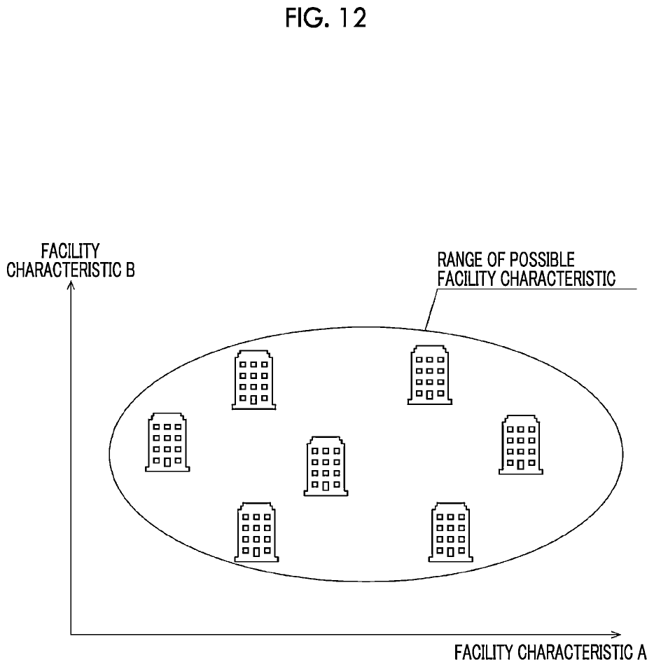

FIG. 12 is an explanatory diagram showing a diversity of facilities assumed as an introduction destination of the suggestion system 10. In order to secure the diversity of the candidate models, first, it is considered what kind of facility having facility characteristics may be possible as an unknown introduction destination facility. Each of the horizontal axis and the vertical axis in FIG. 12 represents some kind of facility characteristic. Although FIG. 12 shows a vector space on two axes of the facility characteristic A and the facility characteristic B, the actual facility characteristic can be multidimensional. The facility characteristics include, for example, in the case of a hospital, the distribution of ages (age group) of patients and the ratio of medical history such as what kind of illness a large number of people have.

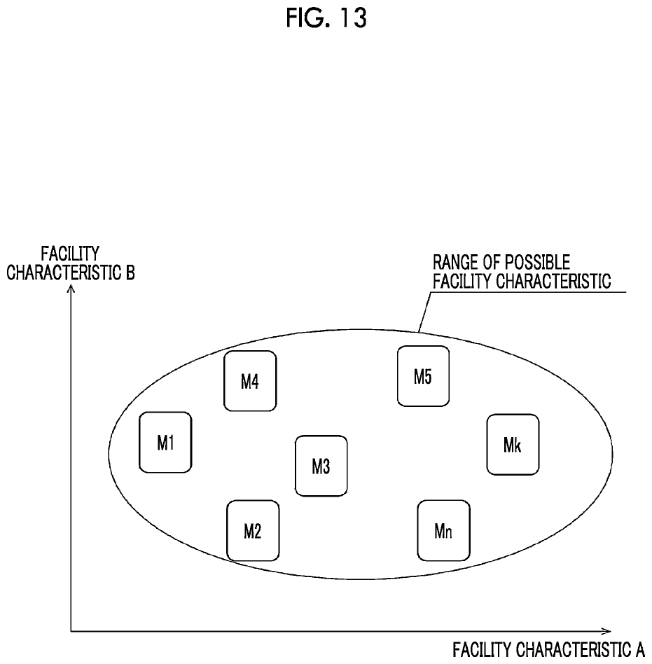

The facility characteristics assumed as an unknown introduction destination facility are distributed in, for example, a range surrounded by an elliptical-shaped closed curve in FIG. 12. Regardless of which facility is selected as the introduction destination within the range of possible facility characteristics as the introduction destination facility, it is desired to have a model suitable for the facility in the candidate model set. That is, as shown in FIG. 13, it is desirable that a plurality of models M1, M2, M3, Mk . . . Mn included in the candidate model set are distributed substantially evenly within the range of possible facility characteristics.

In a case where there are many facilities where data used for a training can be collected, and in a case where the facility data used for a training is sufficiently large and diverse, it is relatively easy to prepare a suitable model in the candidate model set for a possible facility.

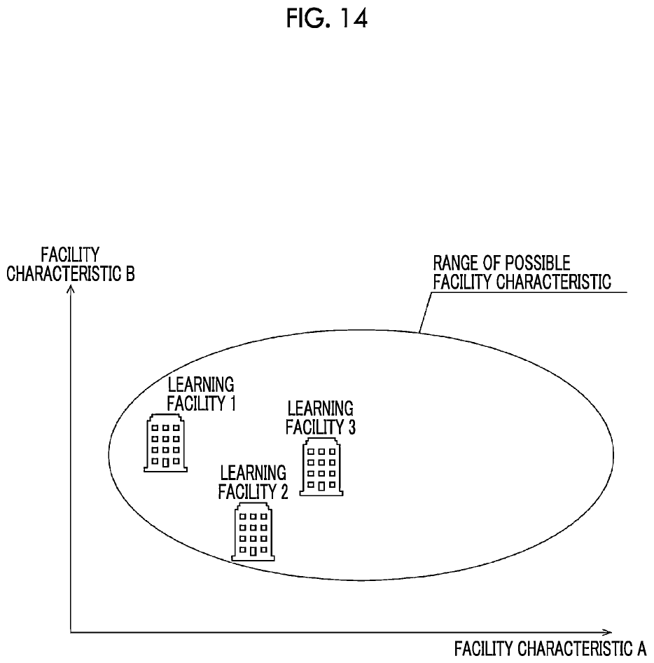

However, in reality, as shown in FIG. 14, the number of facilities (hereinafter, referred to as learning facilities) where data used for training the model can be collected is small, and the data used for training is often not so diverse. In the figure, the notations with the number of “learning facility 1”, “learning facility 2”, and “learning facility 3” represent that the facilities are different. For example, data that can be used for a training may be only the data obtained from the learning facilities 1 to 3.

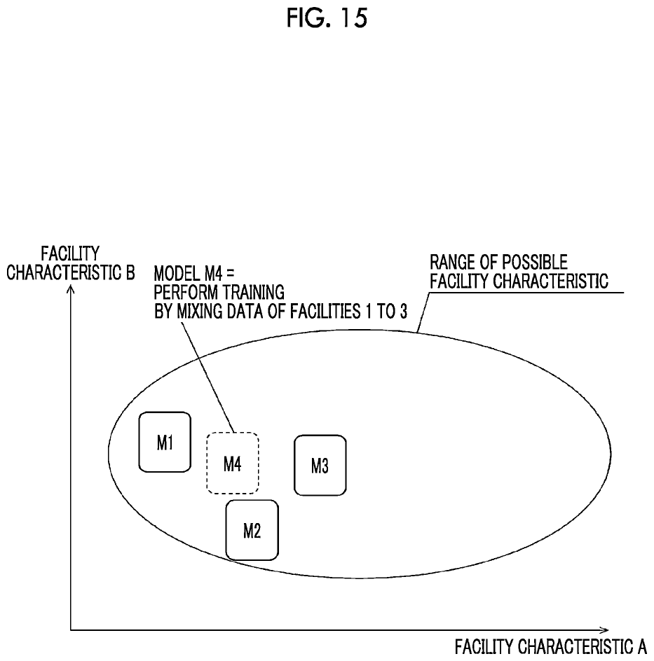

The learning facilities 1 to 3 shown in FIG. 14 are unevenly distributed in a limited range within a range of possible facility characteristics. In this case, as shown in FIG. 15, the candidate model can be prepared only within the range of the characteristics of the learning facility. The model M1 in FIG. 15 is a model trained by using the data of the learning facility 1. Similarly, the model M2 in FIG. 15 is a model trained by using the data of the learning facility 2, and the model M3 is a model trained by using the data of the learning facility 3. The model M4 in FIG. 15 is a model in which the data of the learning facilities 1 to 3 are mixed and trained. That is, it is not possible to build a model that can cover the right half area and the upper area of the range of possible facility characteristics with only the data of the learning facilities 1 to 3, and it is not possible to prepare a model that provides good information suggestion with respect to the introduction destination facility that has facility characteristics in this area.

As described in FIG. 14 and FIG. 15, in a case where the learning facilities are not enough, the diversity of the plurality of candidate models that can be prepared is not sufficient, and the range of possible facility characteristics is not sufficiently covered, thereby it is difficult to prepare a suitable model in the candidate model set for an assumed unknown introduction destination facility.

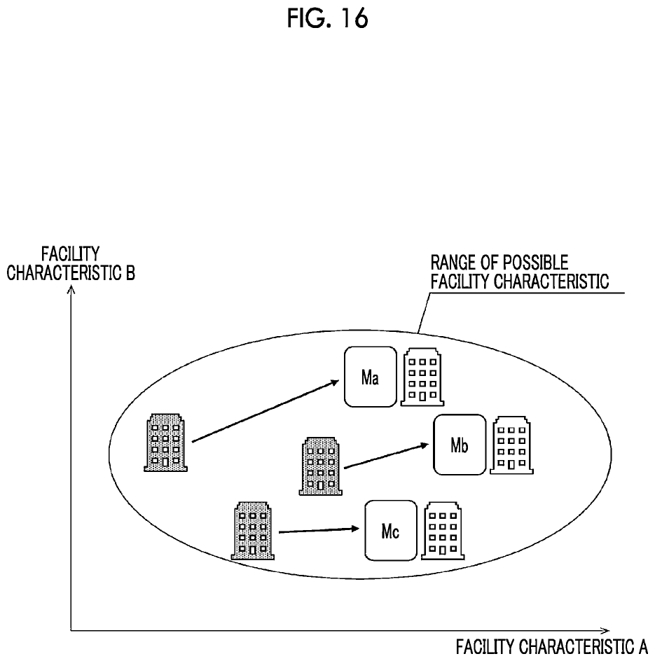

To solve this problem, the present embodiment, as shown in FIG. 16, although it is not a facility characteristic of the learning facilities 1 to 3, an information processing method and an information processing apparatus, which are capable of training a plurality of models Ma, Mb, and Mc corresponding to possible facility characteristics of the introduction destination facility and preparing the plurality models as candidate models, are provided.

### Outline of Information Processing Apparatus According to Embodiment

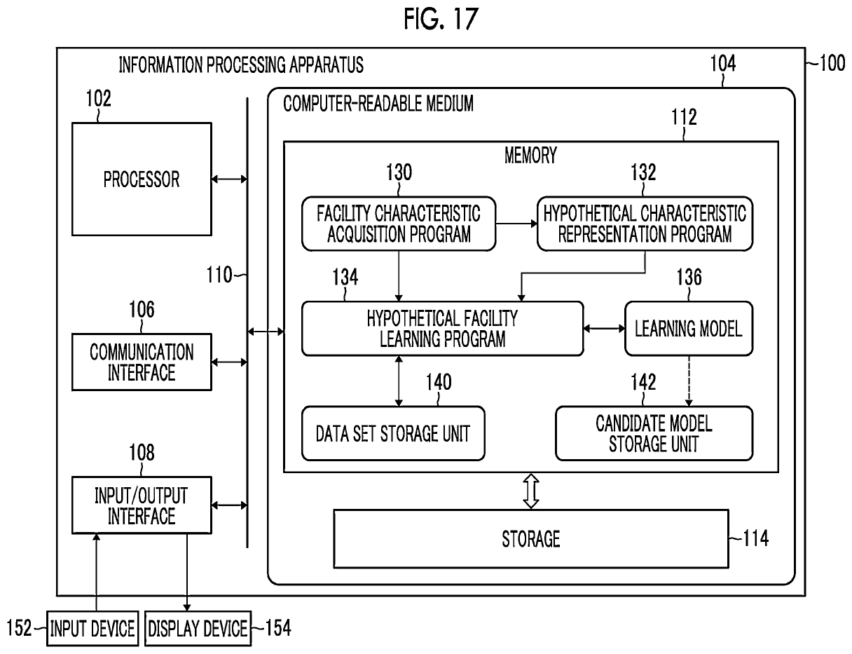

FIG. 17 is a block diagram schematically showing an example of a hardware configuration of an information processing apparatus 100 according to an embodiment. The information processing apparatus 100 includes a function of representing a characteristic of a hypothetical introduction destination facility that is different from the learning facility and a function of training the model such that the prediction performance is improved in the hypothetical introduction destination facility according to the characteristics of the hypothetical introduction destination facility, represents the characteristics of a plurality of hypothetical introduction destination facilities, and trains a plurality of models for each of the plurality of hypothetical introduction destination facilities.

The information processing apparatus 100 generates a model suitable for the hypothetical introduction destination facility by performing up-sampling, and down-sampling that reflect the characteristics of the hypothetical introduction destination facility, by weighting the learning data, or by performing an appropriate combination of these, based on the dataset collected at the learning facility.

Assuming the hypothetical introduction destination facility corresponds to assuming a simultaneous probability distribution Pdh(X, Y), which is a distribution different from the simultaneous probability distribution P(X, Y) of the learning facility (learning domain). The “characteristic of the hypothetical introduction destination facility” is a characteristic of a facility assumed as an unknown introduction destination facility. This assumed facility may be an existing facility or a non-existing facility. The “hypothetical introduction destination facility” is referred to as a “hypothetical facility”. The hypothetical facility may be paraphrased as an “assumed facility”.

The information processing apparatus 100 can be realized by using hardware and software of a computer. The physical form of the information processing apparatus 100 is not particularly limited, and may be a server computer, a workstation, a personal computer, a tablet terminal, or the like. Although an example of realizing a processing function of the information processing apparatus 100 using one computer will be described here, the processing function of the information processing apparatus 100 may be realized by a computer system configured by using a plurality of computers.

The information processing apparatus 100 includes a processor 102, a computer-readable medium 104 that is a non-transitory tangible object, a communication interface 106, an input/output interface 108, and a bus 110.

The processor 102 includes a central processing unit (CPU). The processor 102 may include a graphics processing unit (GPU). The processor 102 is connected to the computer-readable medium 104, the communication interface 106, and the input/output interface 108 via the bus 110. The processor 102 reads out various programs, data, and the like stored in the computer-readable medium 104 and executes various processes. The term program includes the concept of a program module and includes instructions conforming to the program.

The computer-readable medium 104 is, for example, a storage device including a memory 112 which is a main memory and a storage 114 which is an auxiliary storage device. The storage 114 is configured using, for example, a hard disk drive (HDD) device, a solid state drive (SSD) device, an optical disk, a photomagnetic disk, a semiconductor memory, or an appropriate combination thereof. Various programs, data, or the like are stored in the storage 114.

The memory 112 is used as a work area of the processor 102 and is used as a storage unit that temporarily stores the program and various types of data read from the storage 114. By loading the program that is stored in the storage 114 into the memory 112 and executing instructions of the program by the processor 102, the processor 102 functions as a unit for performing various processes defined by the program.

The memory 112 stores various programs such as a facility characteristic acquisition program 130, a hypothetical characteristic representation program 132, a hypothetical facility learning program 134, and a learning model 136 executed by the processor 102, and various types of data and the like. The learning model 136 may be included in the hypothetical facility learning program 134.

The facility characteristic acquisition program 130 is a program that executes a process of acquiring information indicating the characteristics of the learning facility and/or an unknown introduction destination facility. The facility characteristic acquisition program 130 may acquire information indicating the characteristic of the learning facility, for example, by performing a statistical process on the data included in the dataset collected at the learning facility. Further, for example, the facility characteristic acquisition program 130 may receive an input of information indicating the characteristic of the facility via a user interface or may automatically collect public information indicating the characteristic of the facility on the Internet.

The hypothetical characteristic representation program 132 is a program that executes a process of representing the characteristic of a hypothetical facility different from the learning facility. The hypothetical characteristic representation program 132 represents, for example, a difference in the probability distribution of the explanatory variables between the learning facility and the hypothetical facility. Further, the hypothetical characteristic representation program 132 may represent, for example, a difference in conditional probabilities between the explanatory variables and the response variables in the learning facility and the hypothetical facility.

The hypothetical facility learning program 134 is a program that executes a process of training the learning model 136 such that the prediction performance is improved in the hypothetical facility according to the characteristic of the hypothetical facility represented by the hypothetical characteristic representation program 132.

The memory 112 includes a dataset storage unit 140 and a candidate model storage unit 142. The dataset storage unit 140 is a storage area in which a dataset (hereinafter, referred to as an original dataset) collected in the learning facility is stored. The candidate model storage unit 142 is a storage area in which a candidate model, which is a trained model that is trained by the hypothetical facility learning program 134, is stored.

The communication interface 106 performs a communication process with an external device by wire or wirelessly and exchanges information with the external device. The information processing apparatus 100 is connected to a communication line (not shown) via the communication interface 106. The communication line may be a local area network, a wide area network, or a combination thereof. The communication interface 106 can play a role of a data acquisition unit that receives input of various data such as the original dataset.

The information processing apparatus 100 may include an input device 152 and a display device 154. The input device 152 and the display device 154 are connected to the bus 110 via the input/output interface 108. The input device 152 may be, for example, a keyboard, a mouse, a multi-touch panel, or other pointing device, a voice input device, or an appropriate combination thereof. The display device 154 may be, for example, a liquid crystal display, an organic electro-luminescence (OEL) display, a projector, or an appropriate combination thereof. The input device 152 and the display device 154 may be integrally configured as in the touch panel, or the information processing apparatus 100, the input device 152, and the display device 154 may be integrally configured as in the touch panel type tablet terminal.

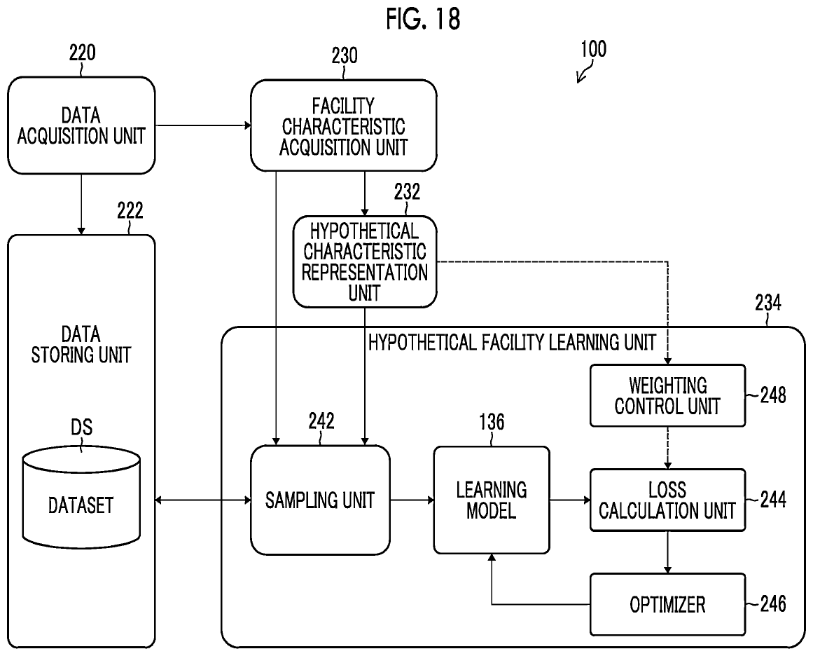

FIG. 18 is a functional block diagram showing a functional configuration of an information processing apparatus 100. The information processing apparatus 100 includes a data acquisition unit 220, a data storing unit 222, a facility characteristic acquisition unit 230, a hypothetical characteristic representation unit 232, and a hypothetical facility learning unit 234. The data acquisition unit 220 acquires a dataset DS collected at the learning facility. The dataset DS includes a behavior history of a plurality of users on a plurality of items in the learning facility.

The dataset DS, which is acquired via the data acquisition unit 220, is stored in the data storing unit 222. The dataset storage unit 140 (see FIG. 17) is included in the data storing unit 222. A plurality of datasets, which are collected from each of the plurality of learning facilities, may be stored in the data storing unit 222.

The facility characteristic acquisition unit 230 acquires facility characteristic information indicating the characteristic (facility characteristic) of the facility in the learning facility or the like. The facility characteristic acquisition unit 230 may acquire the facility characteristic information of the learning facility by performing a statistical process or the like by using the data of the dataset stored in the data storing unit 222. Further, the facility characteristic acquisition unit 230 may acquire the facility characteristic information of various facilities from public information published on the Internet.

The hypothetical characteristic representation unit 232 represents the characteristic of the hypothetical facility assumed as the introduction destination facility. The hypothetical characteristic representation unit 232 can represent the characteristics of a plurality of hypothetical facilities different from the learning facility. The hypothetical facility learning unit 234 trains the learning model 136 based on the represented characteristic of the hypothetical facility such that the prediction performance is improved in the hypothetical facility. The hypothetical facility learning unit 234 may generate a plurality of learning models 136 corresponding to each hypothetical facility based on the respective characteristics of the plurality of hypothetical facilities.

The hypothetical facility learning unit 234 includes a sampling unit 242 that samples learning data from the dataset DS, a learning model 136, a loss calculation unit 244, and an optimizer 246. The sampling unit 242 performs up-sampling and/or down-sampling according to the characteristic of the hypothetical facility so as to match the data distribution assumed in the hypothetical facility.

The learning data, which is sampled by the sampling unit 242, is input to the learning model 136, and the prediction result corresponding to the input data is output from the learning model 136. The learning model 136 is built as a mathematical model that predicts a behavior of a user on an item.

Based on the prediction (inference) result output from the learning model 136 and the correct answer data (teacher data) associated with the input data, the loss calculation unit 244 calculates a loss value (loss) between the prediction result and the correct answer data.

The optimizer 246 determines the update amount of a parameter of the learning model 136 such that the prediction result, which is output by the learning model 136, approaches the correct answer data, based on the calculation result of the loss and updates the parameter of the learning model 136. The optimizer 246 updates the parameter based on an algorithm such as a gradient descent method. The hypothetical facility learning unit 234 may acquire the learning data one sample at a time and update the parameter, or may perform acquisition of the learning data and update of the parameter in units of a mini-batch in which a plurality of learning data are collected.

In this way, by performing machine learning by using the learning data sampled from the dataset, the parameter of the learning model 136 is optimized, and the learning model 136 that has the desired prediction performance is generated. The trained learning model 136 is stored in the candidate model storage unit 142 (see FIG. 17) as a candidate model.

Further, the hypothetical facility learning unit 234 may include a weighting controller 248 that controls the weight of the learning data in the case of a training. The weighting controller 248 performs weighting of the learning data according to the hypothetical characteristic so as to match the data distribution assumed in the hypothetical facility.

By the hypothetical characteristic representation unit 232 generating the characteristic of the plurality of hypothetical facilities that are different from each other, a plurality of candidate models matched to the respective characteristics can be obtained.

For example, the hypothetical characteristic representation unit 232 represents probability distributions Ph1(X), Ph2(X), and Ph3(X) of explanatory variables that are a plurality of distributions different from each other, as a hypothetical distribution that indicates the characteristic of the hypothetical facility, and the hypothetical facility learning unit 234 trains models Mc1, Mc2, and Mc3 corresponding to the respective characteristics.

For example, the hypothetical characteristic representation unit 232 may represent conditional probabilities Ph1(Y|X), Ph2(Y|X), and Ph3(Y|X) that are a plurality of distributions different from each other, as a hypothetical distribution that indicates the characteristic of the hypothetical facility, and the hypothetical facility learning unit 234 may train models Mc1, Mc2, and Mc3 corresponding to the respective characteristics.

### Specific Example of Behavior History

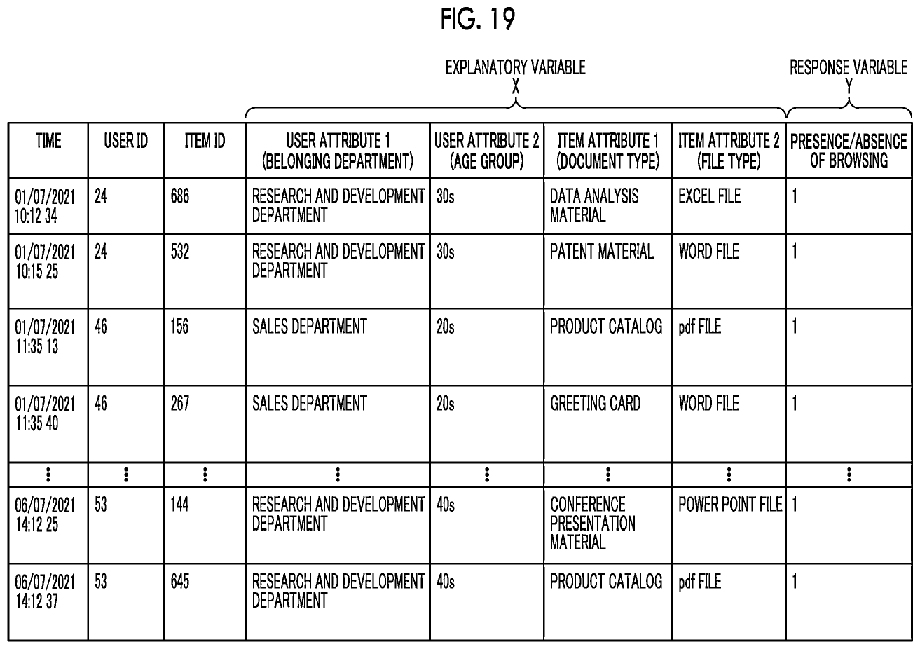

FIG. 19 is a chart showing an example of behavior history data. Here, a case of the behavior history in a document browsing system in a company is considered. FIG. 17 shows an example of a table of a user behavior history related to browsing the document obtained from a document browsing system of a certain company. The “item” here is a document. The table shown in FIG. 17 has columns of “time”, “user ID”, “item ID”, “user attribute 1”, “user attribute 2”, “item attribute 1”, “item attribute 2”, and “presence/absence of browsing”.

The “time” is the date and time when the item is browsed. The “user ID” is an identification code that specifies a user, and an identification (ID) that is unique to each user is defined. The item ID is an identification code that specifies an item, and an ID that is unique to each item is defined. The “user attribute 1” is, for example, a belonging department of a user. The “user attribute 2” is, for example, an age group of a user. The “item attribute 1” is, for example, a document type as a classification category of items. The “item attribute 2” is, for example, a file type of an item. A value of “presence/absence of browsing” in a case of being browsed (presence of browsing) is “1”. Since the number of items that are not browsed is enormous, it is common to record only the browsed item (presence/absence of browsing=1) in the record.

The “presence/absence of browsing” in FIG. 19 is an example of the response variable Y, and each of the “user attribute 1”, “user attribute 2”, “item attribute 1”, and “item attribute 2” is an example of the explanatory variable X. The number of types of the explanatory variables X and the combination thereof are not limited to the example of FIG. 17. The explanatory variable X may further include a context 1, a context 2, a user attribute 3, an item attribute 3, and the like (not shown).

Example of Facility Characteristic

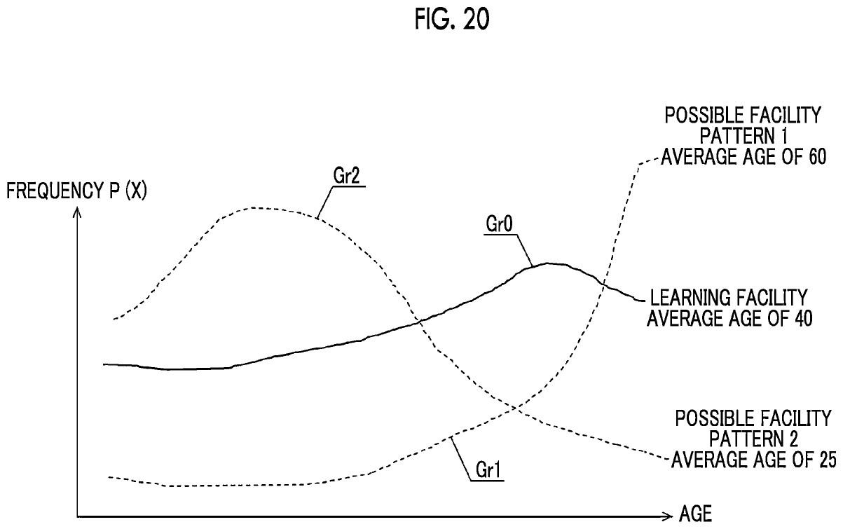

Here, as a specific example of the facility characteristics, the distribution of the ages of the users will be described as an example. FIG. 20 shows an example of the age distribution of users in the learning facility. The horizontal axis represents age and the vertical axis represents frequency. It is understood that the graph shown in FIG. 20 corresponds to a histogram of age of users in a target facility or a density distribution P(X).

In FIG. 20, the graph Gr0 shown by the solid line is the age distribution of the users in the learning facility. In this learning facility, it is assumed that the distribution of ages is relatively even and the average age is, for example, 40. In contrast, in another facility, for example, it is assumed that a ratio of old-aged people is high as in the graph Gr1 (pattern 1), or a ratio of young-aged people is high as in the graph Gr2 (pattern 2). The average age of the hypothetical facility users having the pattern 1 age distribution may be, for example, 60, and the average age of the hypothetical facility users having the pattern 2 age distribution may be, for example, 25.

Such a difference in the age distribution of users between facilities corresponds to a kind of “covariate shift” of the domain shift. A possible pattern of the age distribution of an unknown facility assumed as the introduction destination facility can be inferred from the public information such as company information or various statistical information published to the public, for example. For example, the age distribution for each prefecture is open to the public. Even in the case of a company, the average age of employees is disclosed. Further, in the case of a hospital as well, the results of a questionnaire such as a patient satisfaction survey may be disclosed, and the attribute distribution of respondents may be included in the results. Based on such public information, easily available information, and the like, the assumed age distribution of the facility can be estimated in advance.

Description of Learning Method

Next, a learning method executed by the information processing apparatus 100 will be described. Here, a case of matrix factorization, which is frequently used in information suggestion, will be described as an example. In a case where there is data such as a table shown in FIG. 19 as a user behavior history in the learning facility, the processor 102 first trains the dependency between the variables based on this data. More specifically, the processor 102 represents the user and the item as vectors, uses a model whose behavior probability is the sum of the respective inner products, and updates parameters of the model so as to minimize a behavior prediction error.

The vector representation of users is represented by, for example, the addition of the vector representation of each attribute of the user. The same applies to the vector representation of items. The model in which the dependency between the variables is trained corresponds to representation of the simultaneous probability distribution P(X, Y) between the response variable Y and each explanatory variable X in the dataset of the given behavior history.

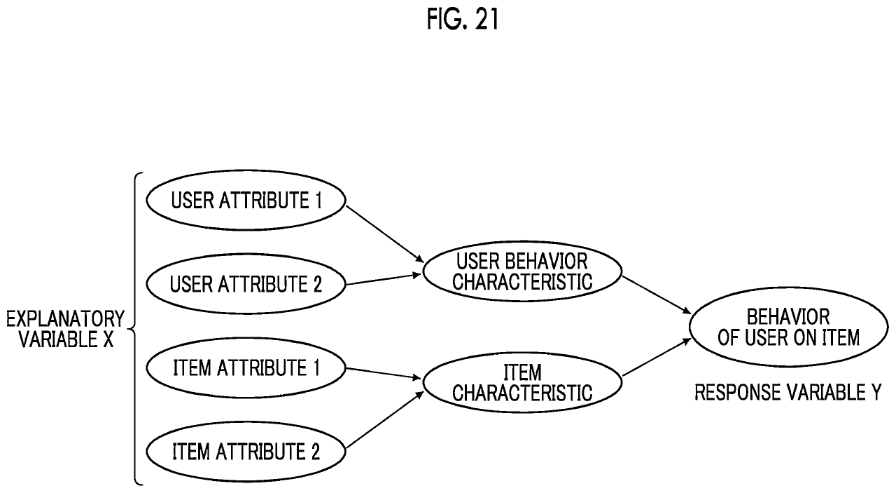

FIG. 21 is an example of a directed acyclic graph (DAG) representing a dependency relationship between variables of a simultaneous probability distribution P(X, Y). FIG. 21 shows an example in which four variables, user attribute 1, user attribute 2, item attribute 1, and item attribute 2, are used as the explanatory variables X. The relationship between each of these explanatory variables X and the behavior of the user on the item, which is the response variable Y, is represented by, for example, a graph as shown in FIG. 21.

In the case of a training, for example, a vector representation of the simultaneous probability distribution P(X, Y) is obtained based on the dependency relationship between variables such as DAG shown in FIG. 21. The graph shown in FIG. 21 shows that the behavior of the user on the item, which is the response variable, depends on the user behavioral characteristic and the item characteristic, shows that the user behavior characteristic depends on user attribute 1 and user attribute 2, and shows that the item characteristic depends on item attribute 1 and item attribute 2.

As shown in FIG. 21, the combination of the user attribute 1 and the user attribute 2 defines the user behavior characteristic. Further, the combination of the item attribute 1 and the item attribute 2 defines the item characteristic. The behavior of the user on the item is defined by a combination of the user behavior characteristic and the item characteristic.

In general, the relationship of P(X, Y)=P(X)×P(Y|X) is established, and in a case where the graph of FIG. 21 is applied to this expression, it is represented as follows.

P(X)=P(user attribute 1,user attribute 2,item attribute 1,item attribute 2)

P(Y|X)=P(behavior of user on item|user attribute1,user attribute2,item attribute1,item attribute2)

P(X,Y)=P(user attribute1,user attribute2,item attribute1,item attribute2)×P(behavior of user on item|user attribute1,user attribute2,item attribute1,item attribute2)

Further, the graph shown in FIG. 21 indicates that the elements can be decomposed as follows.

P(Y|X)=P(behavior of user on item|user behavior characteristic,item characteristic)×P(user behavior characteristic|user attribute1,user attribute2)×P(item behavior characteristic|item attribute1,item attribute2)

Example of Probability Representation of Conditional Probability Distribution P(Y|X)

For example, the probability that the user browses the item (Y=1) is represented by a sigmoid function of the inner product of a user characteristic vector and an item characteristic vector. Such a representation method is called a matrix factorization. The reason why the sigmoid function is adopted is that a value of the sigmoid function can be in a range of 0 to 1 and a value of the function can directly correspond to the probability. The present embodiment is not limited to the sigmoid function, a model representation using another function may be used.

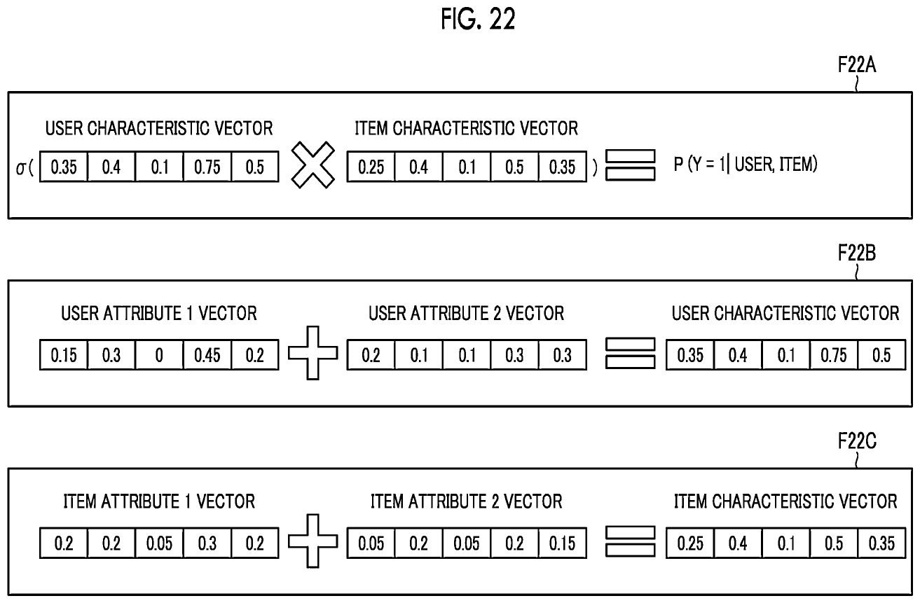

FIG. 22 shows a specific example of the probability representation of P(Y|X). The expression F22A shown in the upper part in FIG. 22 is an example of an expression that represents each of the user characteristic vector θu and the item characteristic vector (pi as a five-dimensional vector and represents a sigmoid function σ(θu·φi) of these inner products (θu·φi) as a conditional probability P(Y=1|user, item) by using the matrix factorization.

“u” is an index value that distinguishes the users. “i” is an index value that distinguishes the items. The dimension of the vector is not limited to 5 dimensions, and is set to an appropriate number of dimensions as a hyper parameter of the model.

The user characteristic vector Ou is represented by adding up attribute vectors of the users. For example, as in the expression F22B shown in the middle part in FIG. 22, the user characteristic vector θu is represented by the sum of the user attribute 1 vector and the user attribute 2 vector. Further, the item characteristic vector (pi is represented by adding attribute vectors of the items. For example, as in the expression F22C shown in the lower part in FIG. 22, the item characteristic vector (pi is represented by the sum of the item attribute 1 vector and the item attribute 2 vector.

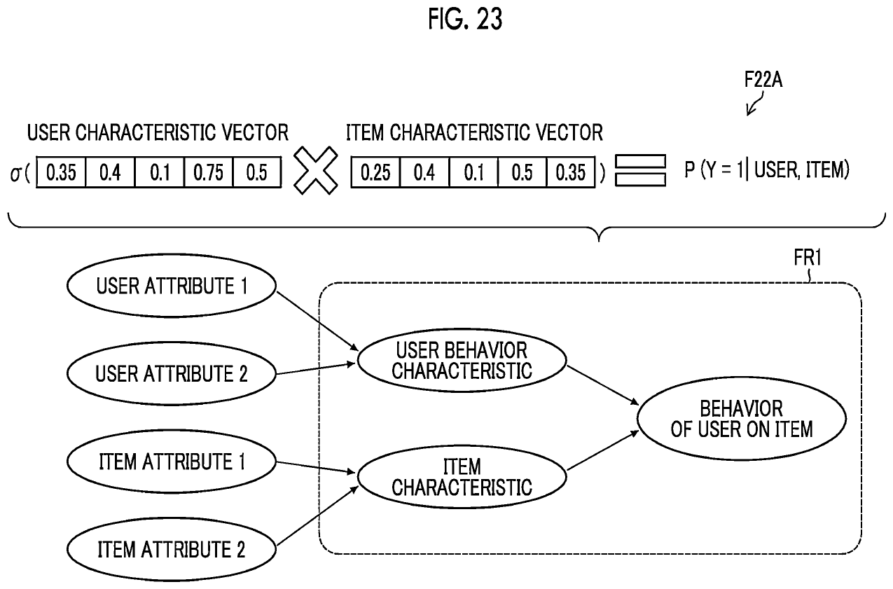

FIG. 23 is an explanatory diagram showing a relationship between the expression F22A, which represents a conditional probability of a behavior of a user on an item (Y=1) for a combination of a user behavior characteristic and an item characteristic, and a DAG representing a dependency relationship between variables of the simultaneous probability distribution P(X, Y). As shown in FIG. 23, the expression F22A represents the conditional probability of a portion of the DAG shown in FIG. 23 surrounded by a broken line frame FR1.

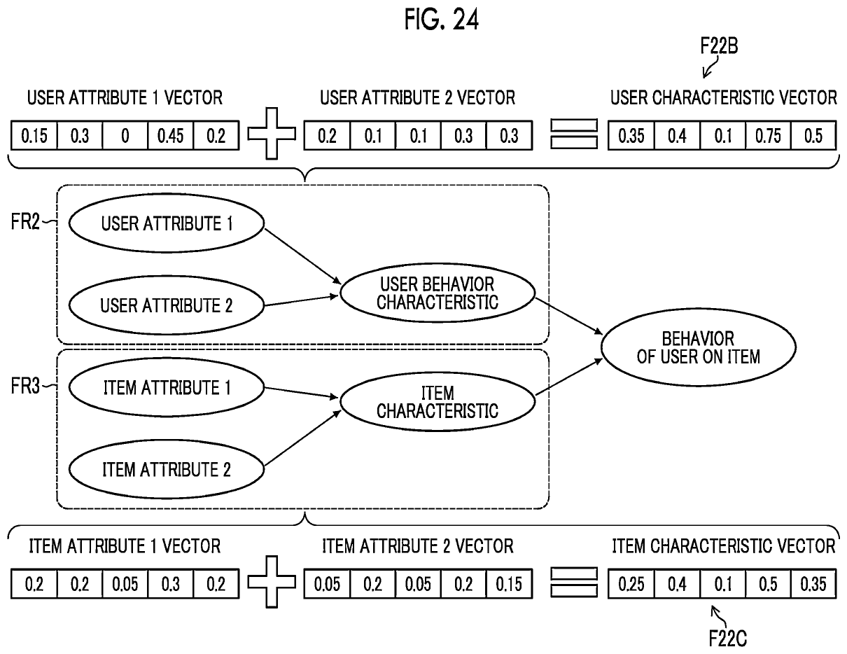

FIG. 24 is an explanatory diagram showing a relationship among a user behavior characteristic defined by a combination of user attribute 1 and user attribute 2, an item characteristic defined by a combination of item attribute 1 and item attribute 2, and a DAG that represents a dependency relationship between variables. As shown in FIG. 24, the expression F22B represents a relationship in a portion surrounded by a frame FR2 indicated by a broken line in the DAG shown in FIG. 24. Further, the expression F22C represents a relationship in a portion surrounded by a frame FR3 indicated by a broken line in the DAG shown in FIG. 24.

A value of each vector shown in FIG. 23 is determined by learning from data (learning data) included in a dataset of a user behavior history of a given domain.

For example, the vector values are updated, for example, by using a stochastic gradient descent (SGD) such that, P(Y=1|user, item) becomes large for a pair of browsed user and item, and P(Y=1|user, item) becomes small for a pair of non-browsed user and item.

In the case of the simultaneous probability distributions P(X, Y) shown in FIG. 23 and FIG. 24, the parameters to be trained from the data are as shown below.
User characteristic vector: θu
Item characteristic vector: φi
User attribute 1 vector: Vk_u\hat{ }1
User attribute 2 vector: Vk_u\hat{ }2
Item attribute 1 vector: Vk_i\hat{ }1
Item attribute 2 vector: Vk_i\hat{ }2

However, these parameters satisfy the following relationships.

θu=Vk_u\hat{ }1+Vk_u\hat{ }2

φi=Vk_i\hat{ }1+Vk_i\hat{ }2

“k” is an index value that distinguishes the attributes. For example, assuming that the user attribute 1 has 10 types of belonging department, the user attribute 2 has age group 6 levels, the item attribute 1 has 20 types of document type, and the item attribute 2 has 5 file types, since the types of attributes are 10+6+20+5=41, the possible value of “k” is 1 to 41. For example, in a case where k=1, it corresponds to a sales department of the user attribute 1, and an index value of the user attribute 1 of the user “u” is represented as k_u\hat{ }1.

The values of each of the vectors of the user attribute 1 vector Vk_u\hat{ }1, the user attribute 2 vector Vk_u\hat{ }2, the item attribute 1 vector Vk_i\hat{ }1, and the item attribute 2 vector Vk_i\hat{ }2 are obtained by training from the learning data.

As a loss function in the case of a training, for example, logloss that is represented by the following Equation (1) is used.

L=−{Yᵤᵢ log σ(θu·φi)+(1 −Yᵤᵢ)log(1−σ(θu·φi))} (1)

In a case where the user “u” browses the item “i”, Yᵤᵢ=1, and the larger the prediction probability σ(θu·φi), the smaller the loss L. On the contrary, in a case where the user “u” does not browse the item “i”, Yᵤᵢ=0, and the smaller σ(θu·φi) is, the smaller the loss L is.

The parameters of the vector representation are trained such that the loss L is reduced. For example, in a case where optimization is performed by using the stochastic gradient descent, one record is randomly selected from all the learning data (one u-i pair is selected out of all u-i pairs in the case of not dependent on the context), the partial derivative (gradient) of each parameter of the loss function is calculated with respect to the selected records, and the parameter is changed such that the loss L becomes smaller in proportion to the magnitude of the gradient.

For example, the parameter of the user attribute 1 vector (Vk_u\hat{ }1) is updated according to the following Equation (2).

$${V}_{k\_u \hat{} 1} - α \frac{\partial }{\partial {V}_{k\_u \hat{} 1}} L \qquad ( 2 )$$

“α” in Equation (2) is a learning speed.

In general, since items with Y=0 are overwhelmingly more than items with Y=1 among many items, in a case where the behavior history data is saved as a table as shown in FIG. 19, only Y=1 is saved, and the pair of user “u” and item “i” that are not included in the behavior history data is trained as Y=0. That is, by storing only the data of the positive example, the negative example can be easily generated as not included in the data of the positive example.

Regarding Model Representation

A method of representing the simultaneous probability distribution of the explanatory variable X and the response variable Y is not limited to matrix factorization. For example, instead of the matrix factorization, logistic regression, Naive Bayes, or the like may be applied. In the case of any prediction model, by performing calibration such that an output score is close to the probability P(Y|X), it can be used as a method of the simultaneous probability distribution. For example, a support vector machine (SVM), a gradient boosting decision tree (GDBT), and a neural network model having any architecture can also be used.

Regarding Sampling of Learning Data

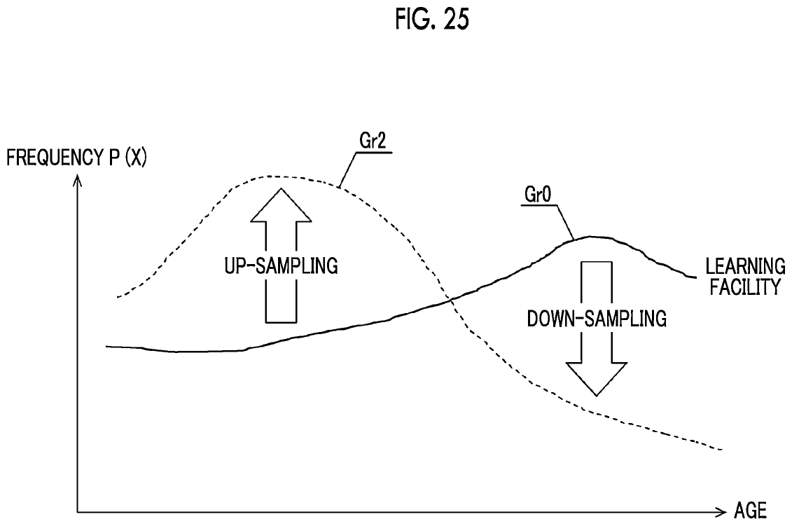

In the present embodiment, the data of the learning facility is up-sampled or down-sampled so as to match the data distribution of the hypothetical facility. FIG. 25 is an explanatory diagram showing an example in a case where learning data is sampled according to the characteristics of a hypothetical facility from a dataset of the learning facility.

FIG. 25 shows an example of a case of sampling the learning data used for a training of a model corresponding to the hypothetical facility having the age distribution of pattern 2 shown in the graph Gr2 in FIG. 20. The processor 102 performs the up-sampling and down-sampling on the data of the learning facility so as to match the age distribution of the pattern 2 (FIG. 25). In the case of the data of the learning facility shown in FIG. 25, since the data of young-aged users is small, as shown in the graph Gr2, the up-sampling is performed on the data for the young-aged users, and since the data of old-aged users is large, the down-sampling is performed. By performing the training by using the data, in which sampling is performed in this manner, it is possible to prepare a model suitable for the hypothetical facility having the age distribution of the pattern 2.

The distribution shown by the graph Gr2 shown in FIG. 25 is an example of a probability distribution representing a difference from the probability distribution of the explanatory variables in the learning facility. Although not shown in the figure, in the case of training the model corresponding to the hypothetical facility having the age distribution shown in the graph Gr1 of FIG. 20, sampling that reflects the distribution of the graph Gr1 may be performed.

Description of Sampling

As described above, in the SGD, one record is selected from the dataset for a training for each step of training. This operation is repeated until the prediction error of the learning model 136 converges.

In a case where the up-sampling or down-sampling is not present, all records are selected (substantially) the same number of times and used for a training. For example, each of the records 1 to 4 included in the table of the dataset is used for a training four times. Since sampling is performed probabilistically, the number of times used for a training may vary within a range of probabilistic fluctuations.

In contrast, for example, it is assumed that up-sampling is performed on the record 1 because of the low age, down-sampling is performed on the record 4 because of the high age, and up-sampling and down-sampling are not performed on the records 2 and 3. In that case, the number of times each record is used for learning is 8 times for the record 1, 4 times for each of the record 2 and the record 3, and 2 times for the record 4.

Example of Weighting of Learning Data

In FIG. 25, although an example corresponding to sampling of data according to the characteristic of the hypothetical facility has been described, instead of or in combination with sampling data, it is possible to similarly generate a model suitable for the hypothetical facility by changing the weight of learning data at the time of the training.

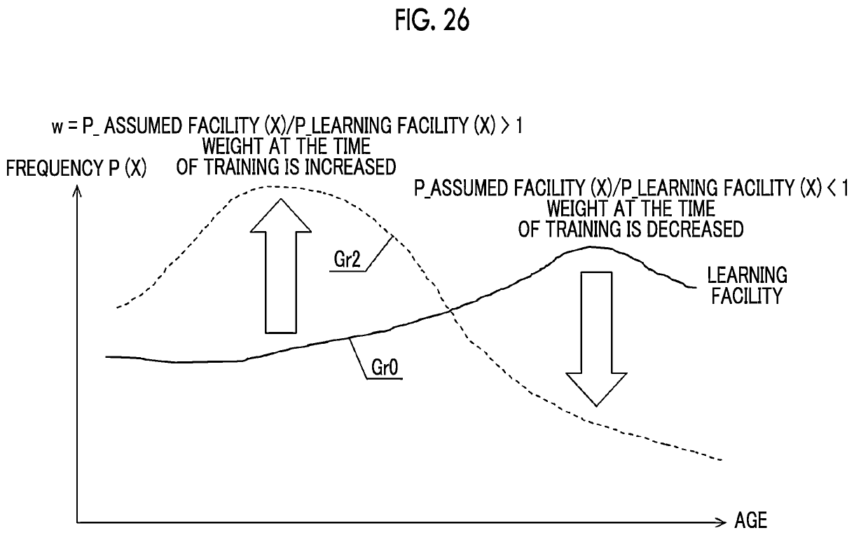

FIG. 26 is an explanatory diagram in a case where the weighting of the learning data is changed according to the characteristics of the hypothetical facility. For example, the processor 102 may use a density ratio of density P_learning facility (X) of the explanatory variables in the learning facility and density P_hypothetical facility (X) of the explanatory variables in the hypothetical facility, weight the learning data, and perform a training.

The density ratio “w” of the explanatory variables between the learning facility and the hypothetical facility is represented by the following equation.

w=P_hypothetical facility(X)/P_learning facility(X)

This density ratio “w” is used as a weight. In a case where w>1, the weight at the time of a training is increased, and in a case where w<1, the weight at the time of a training is decreased.

This is a method called an importance sampling, which is a typical example of a method for covariate shift. Other methods for covariate shift may be applied.

In a case where weighting of the learning data is preformed, a weight wᵤᵢ can be added to each learning record with respect to a loss function described in the equation. That is, instead of Equation (1), the loss function represented by the following Equation (3) can be applied.

L=−wᵤᵢ{Yᵤᵢ log σ(θu·σi)+(1−Yᵤᵢ)log(1−σ(θu·φi))} (3)

A case where weighting is not performed on the learning data corresponds to a case where the weight wᵤᵢ in Equation (3) is always “1”.

In the importance sampling, the weight wu, is defined as the following equation.

wᵤᵢ=P_hypothetical facility(X)/P_learning facility(X)

X is a vector consisting of a combination of explanatory variables, and for example, X=(user attribute 1, user attribute 2, item attribute 1, item attribute 2).

For example, in a case where P(X)=0.1 in the learning facility and P(X)=0.2 in the hypothetical facility, the young-aged user has a weight of wᵤᵢ=0.2/0.1=2 at the time of the training of the data (record) of the young-aged user “u”. Further, for example, in a case where P(X)=0.15 in the learning facility and P(X)=0.05 in the hypothetical facility, the old-aged user has a weight of wᵤᵢ=0.05/0.15=0.33 at the time of the training of the data of the old-aged user “u”.

In Case Where Conditional Probabilities P(Y|X) Are Different

So far, although the embodiment has been described how to deal with the case where the probability distributions P(X) of the explanatory variables as the facility characteristics are different for an example of the age distribution of the users, a plurality of models can be similarly prepared for the case where the conditional probability P(Y|X) differs between the learning facility and the hypothetical facility.

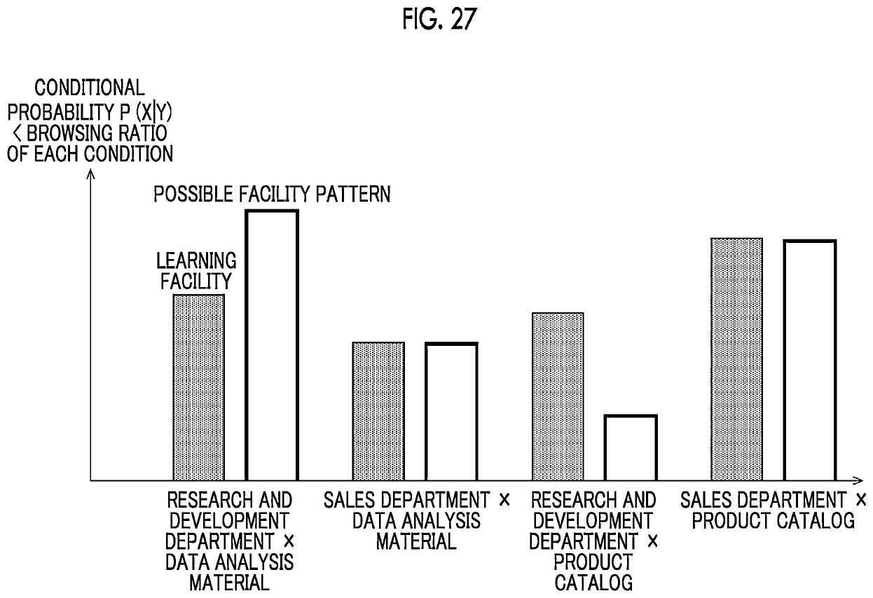

FIG. 27 is a graph schematically showing an example of what kind of document is being browsed by a user in what department in a certain company. FIG. 27 shows the probability that each user of the research and development department and the sales department browses the data analysis material and the probability of browsing a product catalog.

The conditional probability P(Y|X) of what kind of document is being browsed by a user in what department may differ depending on the facility. This corresponds to the concept shift.

FIG. 27 represents an assumption that the types of documents frequently browsed by users in the research and development department differ greatly depending on the facility (company), but the types of documents frequently browsed by users in the sales department do not vary greatly depending on the facility (company).

In this case, the training is performed by excluding “research and development department×document type”, which is a part of “belonging department×document type” of the cross feature amount, from the feature amount of the prediction model. In this way, by excluding the feature amount having a high domain dependence from the feature amount of the prediction model, a model that is robust to the domain shift can be obtained.

Decomposition into Attribute Vector

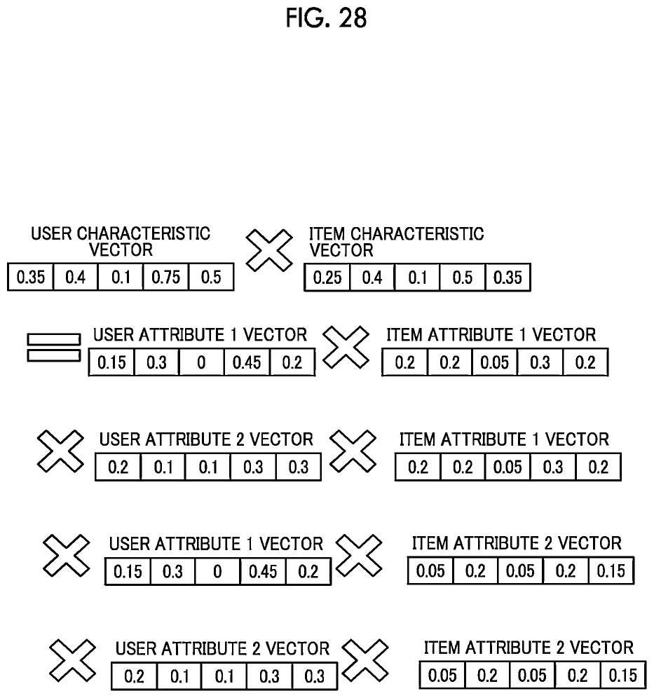

As shown in FIG. 28, the inner product between the user characteristic vector θu and the item characteristic vector (pi described with reference to FIG. 22 is decomposed into the sum of the inner products between the attribute vectors. That is, it can be represented as in the following Equation (4).

θu·φi=(Vk_u\hat{ }1·Vk_i\hat{ }1)+(Vk_u\hat{ }2·Vk_i\hat{ }1)+(Vk_u\hat{ }1·Vk_i\hat{ }2)+(Vk_u\hat{ }2·Vk_i\hat{ }2) (4)

Regarding Cross Feature Amount and Vector Representation

In the suggestion model in which the attribute is represented by a vector, the operation of deleting the cross feature amount is equivalent to restricting the inner product of the corresponding attribute vectors to be zero. For example, to delete the cross feature amount between the research and development department, which is one of the user attributes 1 (belonging department), and the data analysis material, which is one of the item attributes 1 (document type), the inner product between the user attribute 1 vector (the research and development department) with respect to the item attribute 1 and the item attribute 1 vector (the data analysis material) with respect to the user attribute 1 may be restricted to be zero.

This can be realized, for example, by adding a loss proportional to an absolute value of the inner product between the vectors whose inner product is desired to be 0 to the loss function at the time of the training. For example, in order to restrict the inner product with the user attribute 1 with respect to the item attribute 1 vector (data analysis material) to be zero, the loss function as shown in the following Equation is used.

L=−[Yᵤᵢ log σ(θu·φi)+(1−Yᵤᵢ)log(1−σ(θu·φi))]+λΣ|Vk_u\hat{ }1·Vk_i\hat{ }1| (5)

The final term in Equation (5) is a sum including only a combination of the cross feature amounts to be deleted. The coefficient λ is a hyper parameter that controls the magnitude of the loss of this added final term.

As a result, it is possible to improve the prediction accuracy for the item of the user and to correct so that the cross feature amount, which is defined in the final term, is not used.

In a case where it is desired to delete the cross feature amount, that is, in a case where the loss function such as the above-mentioned Equation (5) is desired be introduced to delete the cross feature amount, it is more desirable to use vector representations, which become different depending on the cross target. For example, a method called field-aware factorization machines (FFM) has such a vector representation.

Example of Using Vector Representations Different Depending on Cross Targets

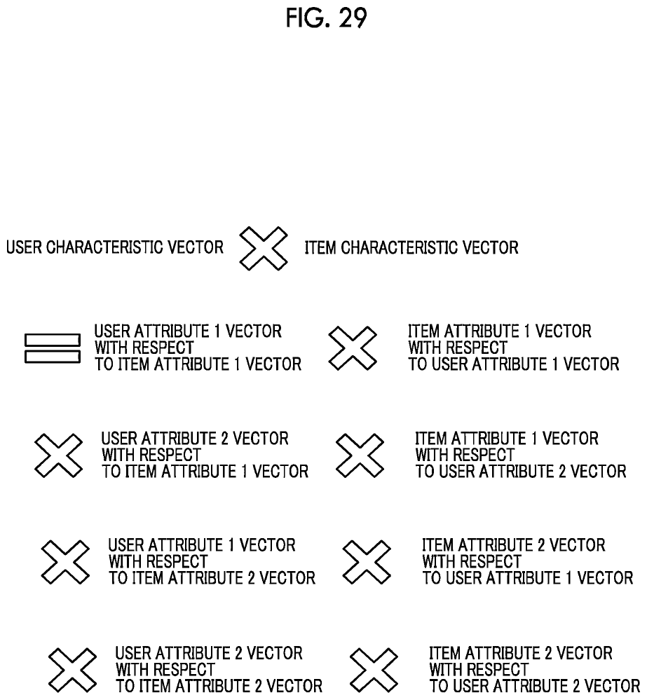

FIG. 29 is an explanatory diagram in a case where vector representations, which become different depending on cross targets, are used. In a case where the attribute vectors, which have vector representations different depending on the cross targets, are used, as shown in FIG. 29, the inner product between the user characteristic vector θu and the item characteristic vector φi is decomposed into the sum of the inner products between the attribute vectors obtained by using the vector representation corresponding to the cross target. That is, in the vector representation of the user attribute 1, the user attribute 1 vector for the item attribute 1 and the user attribute 1 vector for the item attribute 2 are different vectors. Similarly, in the vector representation of the item attribute 1, the item attribute 1 vector for the user attribute 1 and the item attribute 1 vector for the user attribute 2 are different vectors. The same applies to the vector representation of the user attribute 2 and the vector representation of the item attribute 2.

By adopting such a vector representation, it is possible to effectively perform a training by separating only the cross feature amount to be deleted from the others.

### Specific Application Example

Here, an example of an in-hospital information suggestion system for a hospital will be described. It is assumed that, as a dataset that can be used for the training, there are behavior history (browse history) data, a user attribute (belonging clinical department), and an item attribute (examination type, age group of patient) of a hospital 1, which is a learning facility. In the future, it would be desirable to introduce an in-hospital information suggestion system with respect to many hospitals but since the introduction destination facility (hospital) is undecided, accordingly, the data for that undecided facility is also not prepared.

It is assumed that the distribution of age groups of patients in the hospital 1, which is a learning facility, is 10% for those in their 20s, 10% for those in their 30s, 20% for those in their 40s, 20% for those in their 50s, 20% for those in their 60s, 10% for those in their 70s, and 10% for those in their 80s. The distribution of age groups of patients is an example of the facility characteristic.

The distribution of age groups of patients in such a learning facility can be grasped, for example, by performing a statistical process on the data included in the dataset.

Since it is assumed that the distribution of the age groups of the patients differs depending on the hospital, the processor 102 represents the distribution of the age groups of the patients in a hospital different from the hospital 1 based on the public information. The processor 102 generates, for example, a distribution of age groups of patients in a hospital (hypothetical facility A) where there are more elderly people than in the hospital 1, such that 5% for those in their 20s, 5% for those in their 30s, 10% for those in their 40s, 10% for those in their 50s, 25% for those in their 60s, 30% for those in their 70s, 15% for those in their 80s, and so on.

Similarly, the processor 102 generates a distribution of age groups of patients in a hospital (hypothetical facility B) where there are more young people, such that 20% for those in their 20s, 30% for those in their 30s, 20% for those in their 40s, 10% for those in their 50s, 10% for those in their 60s, 5% for those in their 70s, 5% for those in their 80s, and so on.

Taking a distribution ratio of both the learning facility (hospital 1) and the hypothetical facility A, 0.5 for those in their 20s, 0.5 for those in their 30s, 0.5 for those in their 40s, 0.5 for those in their 50s, 1.25 for those in their 60s, 3.0 for those in their 70s, and 1.5 for those in their 80s.

In a case of training a model by using the data of the learning facility, the processor 102 performs weighting on the age group data of each patient with a weight of a value of the distribution ratio and performs the training. Accordingly, it is possible to train a model (model A) that aims to improve performance in the hypothetical facility A.

Similarly, the processor 102 trains the model by taking a distribution ratio of the hypothetical facility B to the learning facility, performing weighting on the data with a weight of a value of the distribution ratio, and performing the training. Accordingly, it is possible to train a model (model B) that aims to improve performance in the hypothetical facility B.

Further, a model (model O), which is trained without performing weighting, is also prepared by using the data of the original learning facility. The model O may be generated by the processor 102 performing a training by using the dataset of the learning facility, or may be generated by performing a training by an information processing apparatus (not shown) other than the information processing apparatus 100. In this way, the model O, the model A, and the model B are prepared as candidate models.

Even in an unknown facility where the system will be introduced in the future, it is assumed that a distribution of age groups of patients is close to any one of the learning facility, the hypothetical facility A, and the hypothetical facility B. Therefore, any one of the model O, the model A, or the model B can be expected to have high performance at the introduction destination facility.

Thereafter, in a case where the facility where the system is planned to be introduced is specifically specified and the data of the specific facility is available before the system is introduced to the existing specific facility, the processor 102 evaluates the model performance of each of the model O, the model A, and the model B by using data of this specific facility, and extracts a model that is suitable for the specific facility from among these plurality of candidate models based on the evaluation results. For example, in a case where the evaluation result of the model B is the best among the three candidate models, the model B is selected as the optimal model. The specific facility in this case is an example of a “third facility” in the present disclosure. The processor 102 may extract one optimal model from among the plurality of candidate models or may extract two or more models having acceptable equivalent performance.

The hospital 1, which is a learning facility, is an example of a “first facility” in the present disclosure. The model O is an example of a “first model” in the present disclosure. Each of the hypothetical facility A and the hypothetical facility B is an example of a “second facility” in the present disclosure. The distribution of age groups in each of the hypothetical facility A and the hypothetical facility B is an example of a “second facility characteristic” in the present disclosure. Each of the model A and the model B is an example of a “second model” in the present disclosure.

In the above-mentioned example, although a plurality of candidate models are built by training a plurality of models A and B corresponding to each of the plurality of hypothetical facilities A and B from the dataset of the hospital 1, as shown in FIG. 16, in a case where the plurality of datasets, which are collected at each of the plurality of learning facilities, are given, a plurality of candidate models can be built as a whole by training a model corresponding to one or more hypothetical facilities from the dataset of each the learning facilities.

Regarding Program that Operates Computer

It is possible to record a program, which causes a computer to realize some or all of the processing functions of the information processing apparatus 100, in a computer-readable medium, which is an optical disk, a magnetic disk, or a non-temporary information storage medium that is a semiconductor memory or other tangible object, and provide the program through this information storage medium.

Further, instead of storing and providing the program in a non-transitory computer-readable medium such as a tangible object, it is also possible to provide a program signal as a download service by using a telecommunications line such as the Internet.

Further, some or all of the processing functions in the information processing apparatus 100 may be realized by cloud computing or may be provided as a software as a service (SaaS).

Regarding Hardware Configuration of Each Processing Unit

The hardware structure of the processing unit that executes various processes such as the data acquisition unit 220, the facility characteristic acquisition unit 230, the hypothetical characteristic representation unit 232, the hypothetical facility learning unit 234, the sampling unit 242, the weighting controller 248, the loss calculation unit 244, and optimizer 246 in the information processing apparatus 100 is, for example, various processors as described below.

Various processors include a CPU, which is a general-purpose processor that executes a program and functions as various processing units, GPU, a programmable logic device (PLD), which is a processor whose circuit configuration is able to be changed after manufacturing such as a field programmable gate array (FPGA), a dedicated electric circuit, which is a processor having a circuit configuration specially designed to execute specific processing such as an application specific integrated circuit (ASIC), and the like.

One processing unit may be composed of one of these various processors or may be composed of two or more processors of the same type or different types. For example, one processing unit may be configured with a plurality of FPGAs, a combination of CPU and FPGA, or a combination of CPU and GPU. Further, a plurality of processing units may be composed of one processor. As an example of configuring a plurality of processing units with one processor, first, as represented by a computer such as a client or a server, there is a form in which one processor is configured by a combination of one or more CPUs and software, and this processor functions as a plurality of processing units. Second, as represented by a system on chip (SoC) or the like, there is a form in which a processor, which implements the functions of the entire system including a plurality of processing units with one integrated circuit (IC) chip, is used. In this way, the various processing units are configured by using one or more of the above-mentioned various processors as a hardware-like structure.

Further, the hardware-like structure of these various processors is, more specifically, an electric circuit (circuitry) in which circuit elements such as semiconductor elements are combined.

### Advantages of Embodiment

According to the present embodiment, even in a case where there are restrictions on a domain of datasets that can be used for a training in a model learning step, a plurality of models with improved prediction performance can be built in each of a plurality of hypothetical facilities different from the learning facility. It is possible to build a candidate model set including a plurality of models that can handle diverse domains by assuming the characteristics of various facilities that can be introduction destination facilities and training a plurality of models corresponding to each of the characteristics.

According to the present embodiment, in a case where a domain of the facility or the like where the data used for a model learning is collected (learning domain) and a domain of the facility or the like, which is a model destination (introduction destination domain) are different from each other, it is possible to realize the provision of a suggestion item list that is robust against domain shifts.

### Other Application Examples

In the above-described embodiment, although the user behavior related to a document browsing has been described as an example the scope of application of the present disclosure is not limited to document browsing, the present disclosed technology can be applied to user behavior prediction related to various items such as browsing medical images, purchasing products, or contents watching such as videos, regardless of uses.

Others

The present disclosure is not limited to the above-described embodiment, and various modifications can be made without departing from the spirit of the idea of the present disclosed technology.

### EXPLANATION OF REFERENCES

10: suggestion system
12: prediction model
14: model
100: information processing apparatus
102: processor
104: computer-readable medium
106: communication interface
108: input/output interface
110: bus
112: memory
114: storage
130: facility characteristic acquisition program
132: hypothetical characteristic representation program
134: hypothetical facility learning program
136: learning model
140: dataset storage unit
142: candidate model storage unit
152: input device
154: display device
220: data acquisition unit
222: data storing unit
230: facility characteristics acquisition unit
232: hypothetical characteristic representation unit
234: hypothetical facility learning unit
242: sampling unit
244: loss calculation unit
246: optimizer
248: weighting controller
DS: dataset
DS1: dataset
DS2: dataset
DS3: dataset
Dtg: data
F22A: expression
F22B: expression
F22C: expression
FR1: frame
FR2: frame
FR3: frame
Gr0: graph
Gr1: graph
Gr2: graph
IT1: item
IT2: item
IT3: item
M1: model
M2: model
M3: model
M4: model
Mk: model
Mn: model
Ma: model
Mb: model
Mc: model

What is claimed is:

1. An information processing method comprising:
causing one or more processors to include:
representing characteristics of a plurality of second facilities different from a first facility where a dataset, which is used for a training of a model that predicts a behavior of a user on an item, is collected; and
training a plurality of the models such that prediction performance at each of the second facilities is improved according to the characteristics of each of the second facilities.

2. The information processing method according to claim 1,
wherein the one or more processors are configured to train the plurality of models corresponding to each of the plurality of second facilities by using data included in the dataset based on the characteristics of each of the second facilities.

3. The information processing method according to claim 1,
wherein a plurality of the datasets, which are collected from each of a plurality of the first facilities, are prepared, and
the one or more processors are configured to:
represent the characteristics of each of the second facilities different from each of the first facilities; and
train the plurality of models by using data included in each of the datasets based on the characteristics of each of the second facilities.

4. The information processing method according to claim 1,
wherein the one or more processors are configured to represent a difference in a probability distribution of explanatory variables in the first facility and the second facility, as a representation of the characteristic of the second facility.

5. The information processing method according to claim 1,
wherein the one or more processors are configured to represent a difference in a conditional probability between explanatory variables and response variables in the first facility and the second facility, as a representation of the characteristic of the second facility.

6. The information processing method according to claim 1,
wherein the one or more processors are configured to perform the training by sampling data, which is used for the training, from the dataset, according to the characteristic of the second facility.

7. The information processing method according to claim 1,
wherein the one or more processors are configured to perform the training by weighting data included in the dataset, according to the characteristic of the second facility.

8. The information processing method according to claim 1, further comprising:
causing the one or more processors to include selecting a feature amount used in the model, according to the characteristic of the second facility.

9. The information processing method according to claim 8, further comprising:
causing the one or more processors to include performing the training by deleting a part of a cross feature amount, which is represented by a combination of explanatory variables, from the feature amount of the model.

10. The information processing method according to claim 1,
wherein the model is a prediction model used in a suggestion system that suggests an item to a user, and
the characteristic of the second facility, which is represented by the one or more processors, is a characteristic of a hypothetical facility assumed within a range of a characteristic of a facility capable of being an introduction destination facility of the suggestion system.

11. The information processing method according to claim 1,
wherein the dataset includes a behavior history of a plurality of users on a plurality of items in the first facility.

12. The information processing method according to claim 1, further comprising:
causing the one or more processors to include storing a set of a plurality of candidate models, which include the plurality of models generated by performing the training, in a storage device.

13. The information processing method according to claim 1, further comprising:
causing the one or more processors to include storing a set of a plurality of candidate models, which include a first model that is trained to improve prediction performance at the first facility by using data included in the dataset and a plurality of second models that are the plurality of models trained based on the characteristics of each of the plurality of second facilities, in a storage device.

14. The information processing method according to claim 13, further comprising:
causing the one or more processors to include training the first model by using the data included in the dataset.

15. The information processing method according to claim 1, further comprising:
causing the one or more processors to include evaluating performance of each of a plurality of candidate models including the plurality of models by using data collected at a third facility that is different from the first facility and extracting a model suitable for the third facility from among the plurality of candidate models based on an evaluation result.

16. An information processing apparatus comprising:
one or more processors; and
one or more memories in which an instruction executed by the one or more processors is stored,
wherein the one or more processors are configured to:
represent characteristics of a plurality of second facilities different from a first facility where a dataset, which is used for a training of a model that predicts a behavior of a user on an item, is collected; and
train a plurality of the models such that prediction performance at each of the second facilities is improved according to the characteristics of each of the second facilities.

17. A non-transitory, computer-readable tangible recording medium which records thereon a program for causing, when read by a computer, the computer to realize:
a function of representing characteristics of a plurality of second facilities different from a facility where a dataset, which is used for a training of a model that predicts a behavior of a user on an item, is collected; and
a function of training a plurality of the models such that prediction performance at each of the second facilities is improved according to the characteristics of each of the second facilities.
